(19) United States
(12) Patent Application Publication
(10) Pub. No.: US 2025/0237493 A1
(43) Pub. Date: Jul. 24, 2025

(54) Stringed Instrument Scanning System and Related Methods

(71) Applicant: MIDGEA, GmbH, Berlin (DE)

(72) Inventors: Joseph Glaser, II, Nashville, TN (US); Gerhard Anke, Berlin (DE); Michael Dubach, Berlin (DE); Thomas Kuhlebrock, Beverungen (DE)

(21) Appl. No.: 19/037,038

(22) Filed: Jan. 24, 2025

Related U.S. Application Data
(60) Provisional application No. 63/624,771, filed on Jan. 24, 2024.

(51) Int. Cl. G01B 11/14; G10G 5/00; G10G 7/00

(52) U.S. Cl. CPC G01B 11/14; G10G 5/00; G10G 7/00

(57) ABSTRACT

A portable musical instrument scanning system for performing fast and accurate quality control (QC) assessment and diagnosis for stringed instruments, including but not limited to guitars. In some embodiments, the musical instrument scanning system includes a musical instrument holder or stand with an integrated or coupled scanner, a computing device including a display unit configured for wired or wireless communication with the scanner, and a software application program (or “app”) stored on and executable by the computing device.

### CROSS-REFERENCES TO RELATED APPLICATIONS

This application claims the benefit of priority under 35 U.S.C. § 119 (e) of U.S. Patent Application No. 63/624,771 filed Jan. 24, 2024, the entire content of which is incorporated herein by reference.

### FIELD

This disclosure relates to the general field of stringed instruments, and more specifically toward a scanning system for stringed instruments for measuring a variety of parameters of the neck to assess and diagnose quality control issues.

### BACKGROUND

Stringed instruments, such as guitars, are fraught with variables based on a host of factors, including (but not limited to) manufacturing materials (e.g. types of woods use for the neck and fingerboard), construction techniques (e.g. truss rod, no truss rod), the impact of the environment (e.g. heat, humidity), skill level of the assembly personnel and/or luthiers, among others. Based on this, there oftentimes exists a high degree of variability in the quality of a stringed instrument and as such quality control issues can abound in the manufacturing process, creating inefficiency and lost productivity, not to mention reputational harm and loss of income that can result from poor quality control. Currently most (if not all) quality control issues are assessed and diagnosed manually, which is similarly fraught with variability based on such “human factors” including a lack of accountability (e.g. hiding poor quality for fear of poor reviews from management), poor or varied understanding of quality benchmarks, language barriers, varying training and/or skill levels, etc. There exists a need for an automated system for assessing and diagnosing quality control issues for stringed instruments.

### SUMMARY OF THE INVENTION

The present invention overcomes the unmet need in the prior art by providing a portable musical instrument scanning system for performing fast and accurate quality control (QC) assessment and diagnosis for stringed instruments, including but not limited to guitars. In some embodiments, the musical instrument scanning system includes a musical instrument holder or stand with an integrated or coupled scanner, a computing device including a display unit configured for wired or wireless communication with the scanner, and a software application program (or “app”) stored on and executable by the computing device.

In some embodiments, the portable musical instrument holder or stand includes one or more instrument coupling elements configured to engage the musical instrument to hold it in place during scanning. In some embodiments, the musical instrument holder includes a sliding element disposed on a track. In some embodiments, the scanner is mounted on the sliding element. By way of example only, the sliding element may be configured to translate back and forth along the track to position the scanner over various parts of the musical instrument. In some embodiments, the scanner comprises a high-resolution laser scanner. In some embodiments, the portable musical instrument holder may be approximately 1 meter tall, 0.4 meters deep, and 0.3 meters wide.

In some embodiments, the computing device may comprise a smart phone, smart watch, tablet computer, desktop computer, and/or a laptop computer.

In some embodiments, the software app comprises a computer software program stored on a non-transitory storage medium and including a set of instructions that, when executed by a processor, cause the scanner to (1) collect data relating to the musical instrument positioned within the instrument holder, (2) analyze the data collected by the scanner against predetermined data parameters, and (3) display, on a display unit of the computing device, results of the analysis including a recommended disposition of the musical instrument (e.g., “go/no-go for use”, “OK-to-ship”, “back to PLEK machine processing”, “return to vendor”, etc.). In some embodiments, the data collected by the scanner may pertain to specific measurements of the instrument, including but not limited to (and by way of example only) heat map of the fret plane, action at the first and/or twelfth frets, relief measurement, etc.

In some embodiments, the software app may include a simplified user interface, including but not limited to a touchscreen interface. In some embodiments, the software app may use artificial intelligence (AI) to evaluate the musical instrument. In some embodiments, the software app may include a networking module to enable remote supervision of QC decisions and real-time workflow status, for example by way of the Internet, virtual private network (VPN), and the like.

The musical instrument scanning system of the present disclosure may boast a variety of advantageous uses. For example, in some embodiments, the musical instrument scanning system disclosed herein may comprise a final set-up tool for “OK-to-ship”, “back to PLEK machine processing”, “return to vendor” decisions. In some embodiments, the musical instrument scanning system disclosed herein may enable pre-shipping QC proof from vendors. In some embodiments, the musical instrument scanning system disclosed herein enables proof-of-issue feedback to vendors, including recurring issue tracking. In some embodiments, the musical instrument scanning system disclosed herein enables same-view communication with distributors, retailers, and authorized repair outlets. In some embodiments, the musical instrument scanning system disclosed herein enables accurate and efficient record keeping of incoming quality and outgoing setup condition at the time of sale and/or shipping. In some embodiments, the musical instrument scanning system disclosed herein may be used as a training aid for QC and setup employees.

In some embodiments, the musical instrument scanning system disclosed herein is compatible with PLEK machines. In some embodiments, the software app interface may be compatible with PLEK machines such that if the instrument needs to be reworked (e.g., upon completion of scanning/analysis and a “no-go” recommendation by the software app), the software app may be configured to track the progress of the instrument through the reworking process. The musical instrument scanning system of the present disclosure ins advantageous in that it can determine the instrument quality while the instrument is not positioned within a PLEK machine, thereby freeing up the PLEK machine for a more efficient use (e.g., actual instrument repair).

By way of example, the musical instrument scanning system disclosed herein is a high-end tool for musical instruments manufacturers and retailers, professional luthiers, guitar repair experts and technicians. In some embodiments the scanner is capable of scanning almost every fretted instrument-including guitars, basses, ukuleles and mandolins. In some embodiments, the scanner provides a microscopic view of the fingerboard and frets, helping to streamline and standardize production outputs and/or to speed up and improve quality control processes. In some embodiments, scans are undertaken under string tension, which enables the system to show the user the contours of the neck and frets under actual playing conditions.

By way of example, the musical instrument scanning system disclosed herein is capable of performing many useful functions, including but not limited to analyzing the plane of frets and fingerboard, comparing current neck and fret plane relief with an optimum relief curve calculated from current and target instrument specifications, indicating how much fret material needs to be removed to eliminate risk of buzzing and maximize playability for the given specs, and calculating optimal fret relief below individual strings. In some embodiments, the musical instrument scanning system disclosed herein can be used in a broad range of different contexts, including but not limited to quality control, distribution and retail, setup and repair, custom building, and research and development.

By way of example, the scanner disclosed herein supports quality control efforts by providing precise and reliable data about the state of a guitar neck. In this respect, the scanner becomes an invaluable tool for quality control in any scenario. In some embodiments, the data that the scanner produces during scanning can be accessed remotely (e.g., by way of the Internet or “cloud”) by final inspection and quality control experts to enhance the final setup. In addition, the musical instrument scanner disclosed can be used to provide feedback to earlier parts of the production process, such as fret seating, specs for nut and saddle heights. For custom builders and repair experts, a final QC scan is a quick and easy way of ensuring that all target specs have been met. An optional online database of all guitar processing information is also available for further enhancement of final QC checks. In some embodiments, model-specific software templates can be created to quickly load standardized instrument specifications and to speed up processing in a manufacturing environment. Additional templates can be created for individual models to take variations into account, such as different fret size, string gauge or target setup. By way of example, the use of templates also helps to reduce the need for operator input when dealing with instruments produced to consistent model specifications.

By way of example, the scanner disclosed herein supports distribution and retail efforts by offering a reliable means of ensuring consistent and optimal setup for all instruments that pass through a company, as well as providing an invaluable resource when dealing with returns.

The scanner disclosed herein may be particularly useful for setup and repair scenarios. By way of example, a repair shop typically has specific requirements, including but not necessarily limited to: quickly analyzing the customer's instrument and identifying problem areas, having a basis for informed discussion with the customer, being able to feed customer-specific requirements (e.g., action, string gauge, attack) into the mix, being able to visualize the effects of proposed changes to the instrument, and being able to implement the agreed changes precisely.

To assist in these efforts, the musical instrument scanner disclosed herein is an accurate diagnostic tool. Scan results can be discussed with the instrument owner to highlight problem areas. Possible solutions can be talked through while viewing the string graph (for example) before being implemented. From truss rod adjustment through to setup, buzz elimination or a complete refret, the final scans may provide a clear proof of the state of the instrument after the work has been carried out.

For the custom builder, the scanner disclosed herein provides a whole new way of approaching questions of fingerboard design. The accuracy of the scan makes it possible for custom builders to precisely create fingerboards to any specifications of their choosing. Each string is scanned individually, which means a user can focus on any string action and neck relief for each string separately and get much better control over the fret work, including an overview of the radii used for each fret, making it easier to implement unusual radii or check the quality of compound radii. In some embodiments, all the data produced while working on individual instruments may be saved for future reference.

The musical instrument scanning system disclosed herein is the perfect tool for anyone looking to push the boundaries of guitar playability. For example, three-dimensional analysis of the fingerboard and fret plane, which factors in data about fret radii with measured and projected optimal relief under individual strings, makes it possible to achieve a “hybrid parabolic radius”. In essence, the scanner disclosed herein allows a designer to investigate the effects of any envisaged changes before putting them into effect. In addition, different string actions, gauges and setups can be implemented and analyzed with a minimum of changes to the actual guitar itself.

As additional description to the embodiments described below, the present disclosure describes the following embodiments.

Embodiment 1 is a portable musical instrument scanning system configured for performing quality control assessment and diagnosis for stringed musical instruments, comprising: an instrument holder configured to receive a stringed musical instrument, the instrument holder comprising a vertical support member, an adjustable upper instrument coupling assembly movably associated with the vertical support member, and an adjustable lower instrument coupling assembly translatably coupled to the vertical support member; a scanner assembly translatably coupled to the instrument holder, the scanner assembly including a scanner configured to scan the surface of a musical instrument received within the instrument holder to collect data relating to the received stringed musical instrument; and a computer program product embodied in a non-transitory computer-readable storage medium comprising a set of instructions that, when executed by a processor, are configured to cause a computer system to: (1) operate the scanner to collect the data relating to the stringed musical instrument received within the instrument holder; (2) analyze the data collected by the computer system through operation of the scanner against predetermined data parameters; and (3) display, on a display unit of the computer system, results of the analysis including a recommended disposition of the stringed musical instrument.

Embodiment 2 is the portable musical instrument scanning system of embodiment 1, wherein the scanner assembly further comprises a vertical translation member slidably coupled to the vertical support member.

Embodiment 3 is the portable musical instrument scanning system of embodiments 1 or 2, wherein the scanner assembly further comprises a transverse translation member slideably coupled to a transverse housing that is rigidly coupled to the vertical translation member.

Embodiment 4 is the portable musical instrument scanning system of any of embodiments 1 through 3, wherein the scanner is coupled to the transverse translation member.

Embodiment 5 is the portable musical instrument scanning system of any of embodiments 1 through 4, wherein the scanning assembly is configured for translation in a vertical direction and a transverse direction relative to the instrument holder to maximize the scanning range of the scanner relative to the received stringed musical instrument.

Embodiment 6 is the portable musical instrument scanning system of any of embodiments 1 through 5, wherein adjustable upper instrument coupling assembly is configured to receive a headstock of a stringed musical instrument.

Embodiment 7 is the portable musical instrument scanning system of any of embodiments 1 through 6, wherein the lower instrument coupling assembly is configured to receive a body of a stringed musical instrument.

Embodiment 8 is the portable musical instrument scanning system of any of embodiments 1 through 7, wherein the computer system comprises a smart phone, smart watch, tablet computer, desktop computer, or a laptop computer.

Embodiment 9 is the portable musical instrument scanning system of any of embodiments 1 through 8, wherein the instrument holder includes one or more line lasers configured to achieve an overlapped alignment on the surface of the received stringed musical instrument when the received stringed musical instrument is properly positioned within the instrument holder.

Embodiment 10 is the portable musical instrument scanning system of any of embodiments 1 through 9, wherein the data collected by the scanner includes string data.

Embodiment 11 is the portable musical instrument scanning system of any of embodiments 1 through 10, wherein the data collected by the scanner includes fretboard data.

Embodiment 12 is the portable musical instrument scanning system of any of embodiments 1 through 11, wherein the data collected by the scanner includes nut data or saddle data.

Embodiment 13 is the portable musical instrument scanning system of any of embodiments 1 through 12, wherein the predetermined data parameters comprise a custom string configuration input into the computer system by a user.

Embodiment 14 is the portable musical instrument scanning system of any of embodiments 1 through 13, wherein the recommended disposition of the stringed musical instrument includes at least one of a repair recommendation, an adjustment recommendation, and a release recommendation.

Embodiment 15 is the portable musical instrument scanning system of any of embodiments 1 through 14, wherein the scanner comprises a high-resolution scanner.

### BRIEF DESCRIPTION OF THE DRAWINGS

Many advantages of the present invention will be apparent to those skilled in the art with a reading of this specification in conjunction with the attached drawings, wherein like reference numerals are applied to like elements and wherein:

FIG. 1 illustrates an example of a portable musical instrument scanning system for performing fast and accurate quality control (QC) assessment and diagnosis for stringed instruments, according to some embodiments;

FIG. 2 is a perspective view of an example of a musical instrument scanner forming part of the portable musical instrument scanning system of FIG. 1, according to some embodiments;

FIG. 3 is another perspective view of the musical instrument scanner of FIG. 2, according to some embodiments;

FIG. 4 is a front perspective view of the musical instrument scanner of FIG. 2, according to some embodiments;

FIG. 5 is a front plan view of the musical instrument scanner of FIG. 2, according to some embodiments;

FIG. 6 is a rear plan view of the musical instrument scanner of FIG. 2, according to some embodiments;

FIG. 7 is a side plan view of the musical instrument scanner of FIG. 2, according to some embodiments;

FIG. 8 is a perspective view of an example of a vertical support unit forming part of the musical instrument scanner of FIG. 2, according to some embodiments;

FIG. 9 is a front plan view of the vertical support unit of FIG. 8, according to some embodiments;

FIG. 10 is a perspective view of a top portion of the vertical support unit of FIG. 8 coupled with an example of an upper instrument coupling element forming part of the musical instrument scanner of FIG. 2, according to some embodiments;

FIG. 11 is an exploded perspective view of the top portion of the vertical support unit and upper instrument coupling element of FIG. 10, according to some embodiments;

FIG. 12 is a front perspective view of an example of a lower instrument coupling element forming part of the musical instrument scanner of FIG. 2, according to some embodiments;

FIG. 13 is another front perspective view of the lower instrument coupling element of FIG. 12, according to some embodiments;

FIG. 14 is rear perspective view of the lower instrument coupling element of FIG. 11, according to some embodiments;

FIG. 15 is top perspective view of the lower instrument coupling element of FIG. 11, according to some embodiments;

FIG. 16 is a perspective view of an example of an adjustable base unit forming part of the lower instrument coupling element of FIG. 12, according to some embodiments;

FIG. 17 is a perspective view of an example of front body engagement assembly forming part of the lower instrument coupling element of FIG. 12, according to some embodiments;

FIG. 18 is a perspective view of an example of bottom body engagement assembly forming part of the lower instrument coupling element of FIG. 12, according to some embodiments;

FIG. 19 is an enlarged closeup perspective view of a portion of the musical instrument scanner of FIG. 2, illustrating in particular an example of a scanning unit forming part of the musical instrument scanner of FIG. 2, according to some embodiments;

FIG. 20 is a side plan view of an upper portion of the musical instrument scanner of FIG. 2, according to some embodiments;

FIG. 21 is a rear perspective view of the upper portion of the musical instrument scanner of FIG. 20, according to some embodiments;

FIGS. 22-34 illustrate sample interactive elements of a status bar that a computer forming part of the portable musical instrument scanning system of FIG. 1 may present to a user on a main user interface screen, according to some embodiments;

FIGS. 35-46 illustrate a sample workflow that a computer forming part of the portable musical instrument scanning system of FIG. 1 may present to a user and the user may follow to calibrate the scanner, according to some embodiments;

FIG. 47 illustrates an example of a main user interface screen that a computer forming part of the portable musical instrument scanning system of FIG. 1 may present to the user on a display screen of the user's computing device upon the user opening the software app, according to some embodiments;

FIGS. 48-51 illustrate a sample workflow that a computer forming part of the portable musical instrument scanning system of FIG. 1 may present to a user and the user may follow to create a new instrument file in the software app, according to some embodiments;

FIGS. 52-58 illustrate a sample workflow that a computer forming part of the portable musical instrument scanning system of FIG. 1 may present to a user and the user may follow to create a new template file in the software app, according to some embodiments;

FIG. 59 illustrates another example of a main user interface screen that a computer forming part of the portable musical instrument scanning system of FIG. 1 may present to the user on a display screen of the user's computing device upon the user opening the software app, according to some embodiments;

FIG. 60 illustrates an example of a scan overview user interface screen that a computer forming part of the portable musical instrument scanning system of FIG. 1 may present to the user on a display screen of the user's computing device during use of the portable musical instrument scanning system, according to some embodiments;

FIGS. 61-62 illustrate examples of a side view user interface screens that a computer forming part of the portable musical instrument scanning system of FIG. 1 may present to the user on a display screen of the user's computing device during use of the portable musical instrument scanning system, according to some embodiments;

FIG. 63 illustrates an example of a buzz value graph user interface screen that a computer forming part of the portable musical instrument scanning system of FIG. 1 may present to the user on a display screen of the user's computing device during use of the portable musical instrument scanning system, according to some embodiments;

FIG. 64 illustrates an example of a string graph user interface screen that a computer forming part of the portable musical instrument scanning system of FIG. 1 may present to the user on a display screen of the user's computing device during use of the portable musical instrument scanning system, according to some embodiments;

FIG. 65 illustrates an example of a truss rod scan user interface screen that a computer forming part of the portable musical instrument scanning system of FIG. 1 may present to the user on a display screen of the user's computing device during use of the portable musical instrument scanning system, according to some embodiments;

FIG. 66 illustrates an example of a scale and fret placement window user interface screen that a computer forming part of the portable musical instrument scanning system of FIG. 1 may present to the user on a display screen of the user's computing device during use of the portable musical instrument scanning system, according to some embodiments;

FIG. 67 illustrates an example of a fret placement graph user interface screen that a computer forming part of the portable musical instrument scanning system of FIG. 1 may present to the user on a display screen of the user's computing device during use of the portable musical instrument scanning system, according to some embodiments;

FIGS. 68-70 illustrate examples of isolated string spacing graph user interface screens that a computer forming part of the portable musical instrument scanning system of FIG. 1 may present to the user on a display screen of the user's computing device during use of the portable musical instrument scanning system, according to some embodiments;

FIGS. 71-72 illustrate examples of action setup user interface screens that a computer forming part of the portable musical instrument scanning system of FIG. 1 may present to the user on a display screen of the user's computing device during use of the portable musical instrument scanning system, according to some embodiments;

FIG. 73 illustrates an example of a nut and saddle setup user interface screen that a computer forming part of the portable musical instrument scanning system of FIG. 1 may present to the user on a display screen of the user's computing device during use of the portable musical instrument scanning system, according to some embodiments; and

FIGS. 74-75 are block diagrams of example computing devices configured for use with the portable musical instrument scanning system of FIG. 1, according to some embodiments.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure. The scanning system and methods for stringed musical instruments disclosed herein boasts a variety of inventive features and components that warrant patent protection, both individually and in combination.

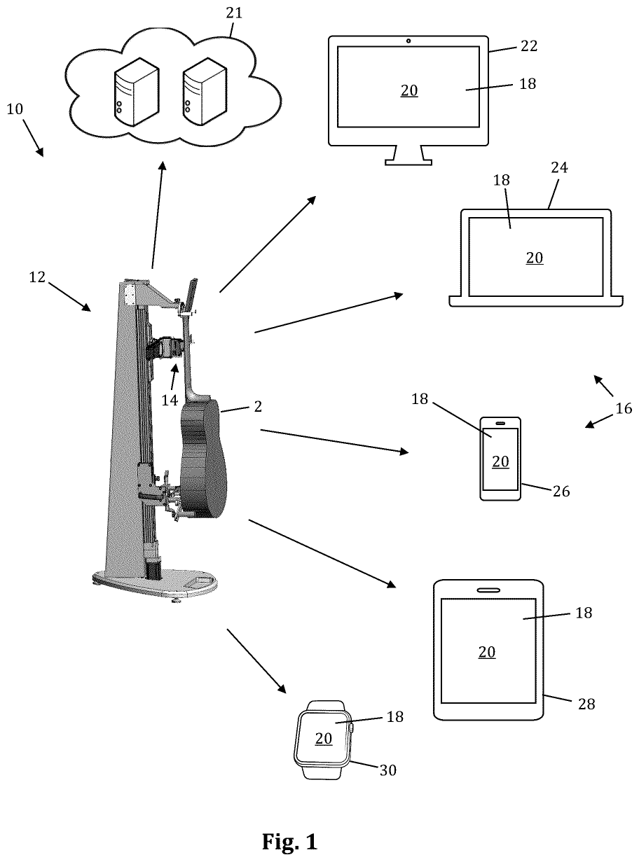

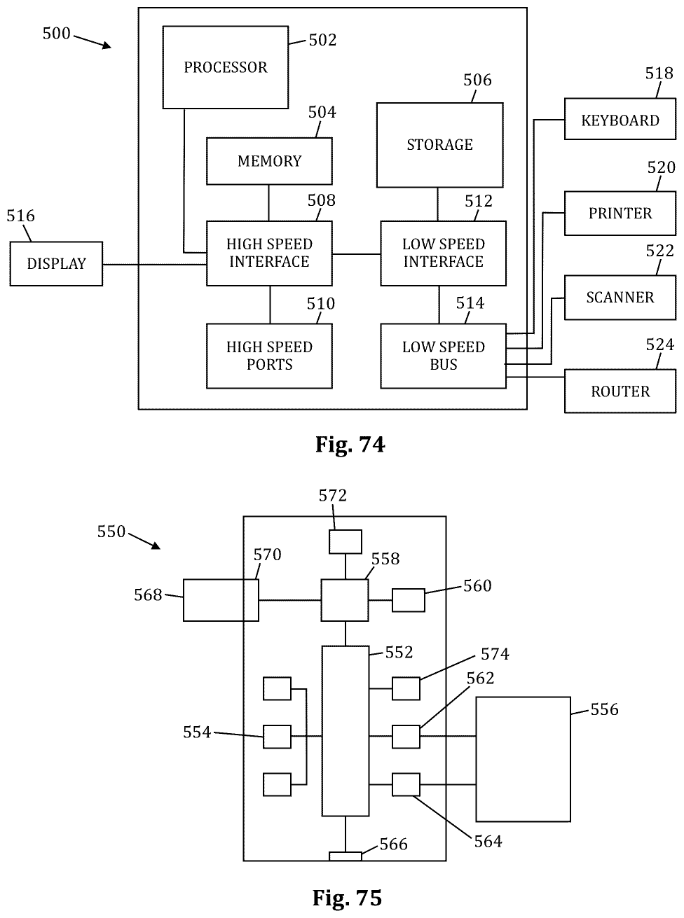

By way of example only, FIG. 1 illustrates an example of a portable musical instrument scanning system 10 for performing fast and accurate quality control (QC) assessment and diagnosis for stringed instruments, including but not limited to guitars, according to some embodiments. In some embodiments, the musical instrument scanning system 10 includes a musical instrument holder 12 with an integrated or coupled scanner 14, a computing device 16 including a display unit 18 configured for wired or wireless communication with the scanner 14, and a software application program (or “app”) 20 stored on and executable by the computing device 14. By way of example, the musical instrument holder 12 is configured to securely and gently hold a musical instrument 2 in place during scanning. In some embodiments, the computing device 16 may comprise a desktop computer 22, laptop computer 24, smart phone 26, tablet computer 28, and/or smart watch 30. By way of example, as described herein below with reference to FIGS. 74-75, the computing device 16 (or “computer 16”) comprises a processor, memory, storage unit, and communications module, among other components that collectively execute the set of instructions embodied in the software app 20 to enable the computer 16 to interact with a user as described herein. In some embodiments, the scanner 14 and/or computing device 16 may have wired or wireless data communication with the Internet, including the “cloud” 21. As used herein, actions undertaken by the computer 16 in response to user input and/or displays presented by the computer 16 to a user (e.g., interactive options, analysis, etc.) is a result of the processor executing the set of instructions embodied in the software app 20.

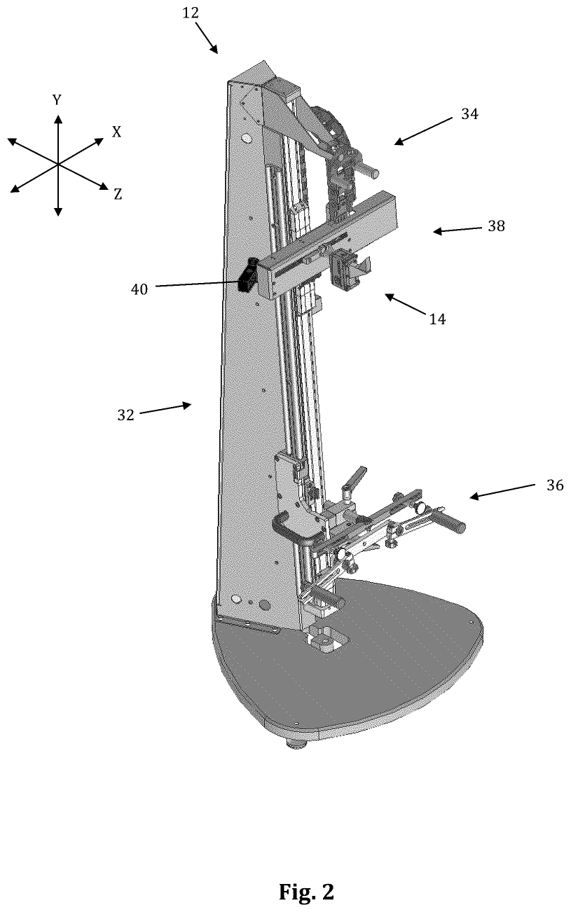

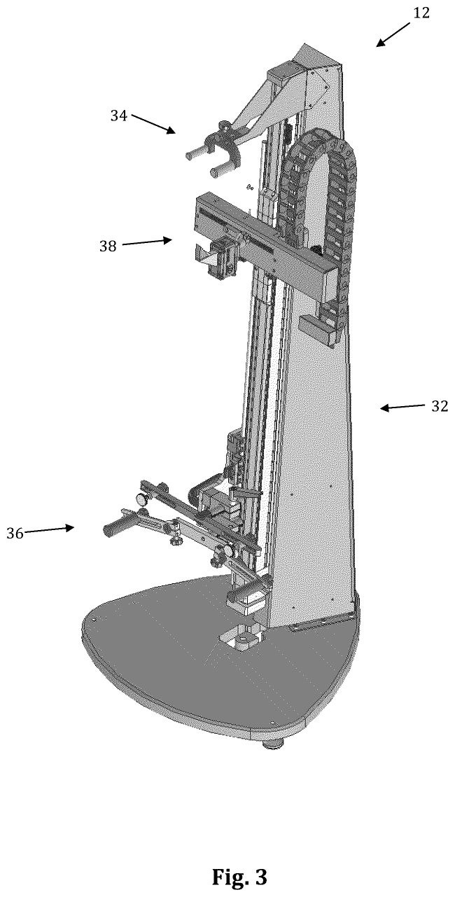

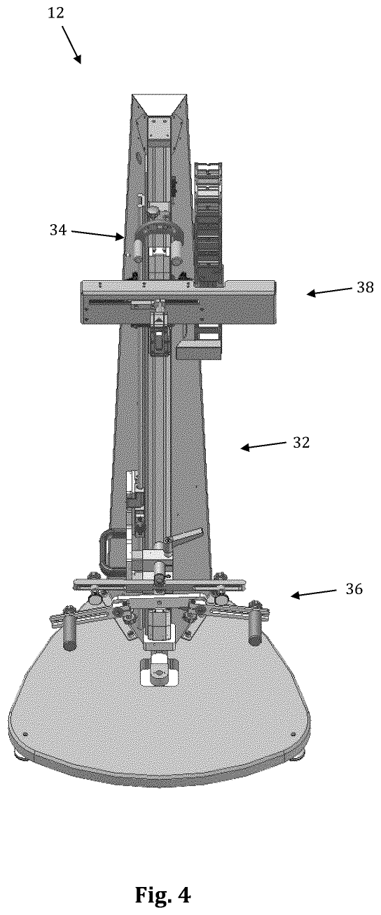

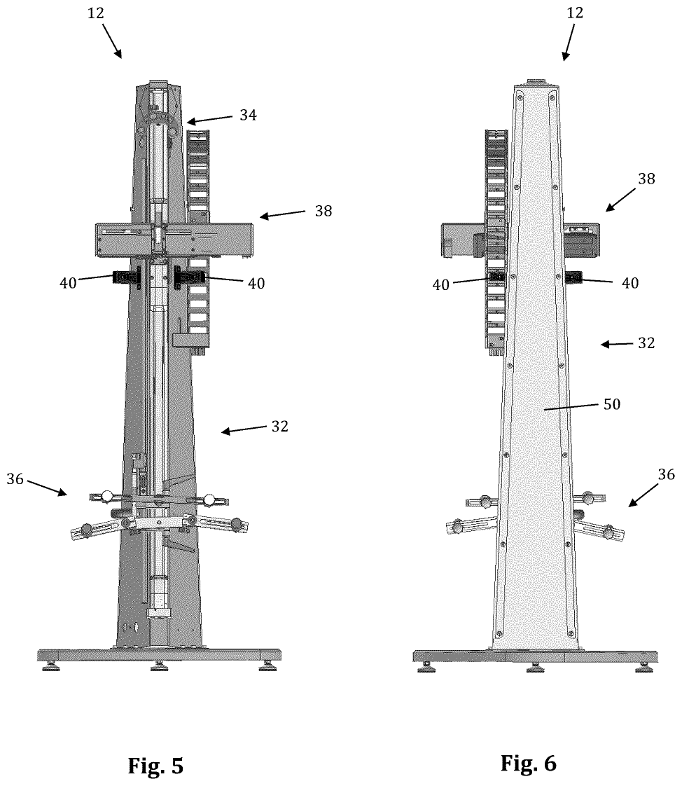

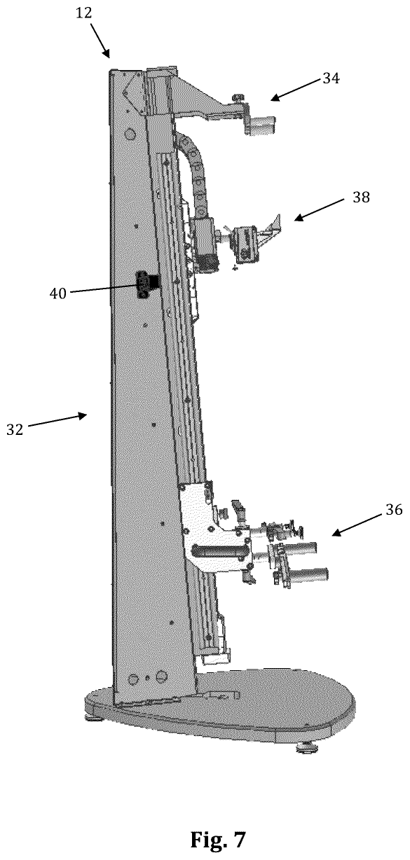

FIGS. 2-7 illustrate a portable musical instrument holder 12 forming part of the musical instrument scanning system 10 according to some embodiments. In some embodiments, the portable musical instrument holder 12 includes vertical support unit 32, an upper instrument coupling assembly 34, and a lower instrument coupling assembly 36, a scanning laser assembly 38, and a pair of line lasers 40 positioned on either side of the vertical support unit 32. In some embodiments, the vertical support unit 32, upper instrument coupling assembly 34, and lower instrument coupling assembly 36 are configured to engage the musical instrument 2 to hold the musical instrument in place during scanning. As will be described in further detail below, in some embodiments the scanning laser assembly 38 may be configured for both vertical movement (e.g., along a Y-axis) and horizontal movement (e.g., along an X-axis) to enable comprehensive scanning of the coupled musical instrument 2. In some embodiments, the upper instrument coupling assembly 34 may be configured for horizontal adjustment and depth adjustment (e.g., along a Z-axis). In some embodiments, the lower instrument coupling assembly 36 may be configured for vertical movement (e.g., Y-axis) and depth adjustment (e.g., Z-axis).

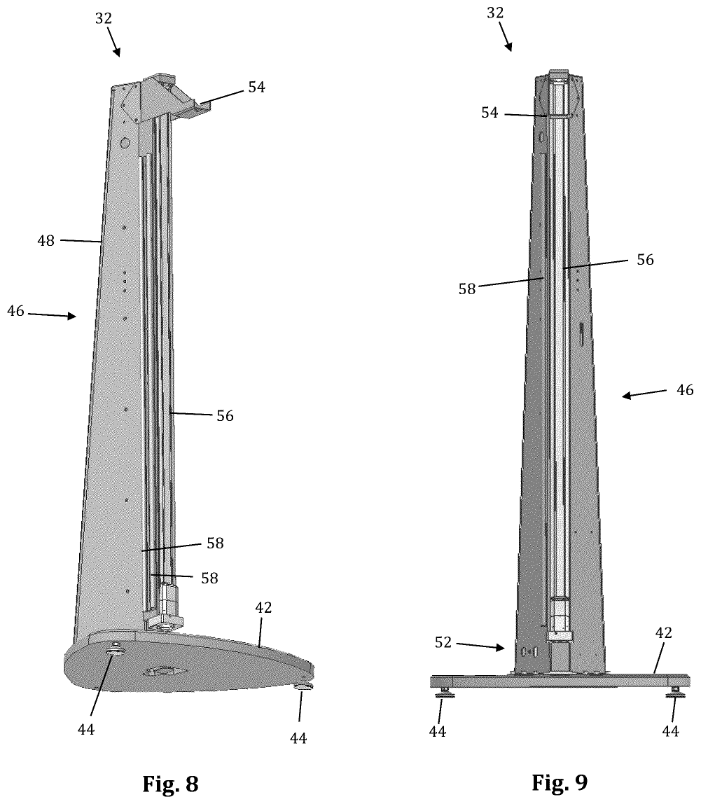

FIGS. 8-9 illustrate an example of a vertical support unit 32 forming part of the musical instrument holder 12, according to some embodiments. In some embodiments, the vertical support unit 32 may include a base 42 having a transverse width component sufficient to prevent the vertical support 32 from toppling over, and a plurality of feet members 44 configured to interface with a resting surface upon which the musical instrument holder 12 is placed. In some embodiments, the vertical support unit 32 comprises an elongated electronics cabinet 46 having a pair of side panels 48 and a back panel 50 (e.g., see FIG. 6). In some embodiments, one of the side panels 48 may include a plurality of apertures 52 positioned near the base 42 and configured to enable various components (e.g., power switch, power socket, and/or LAN socket) to protrude from the electronics cabinet 46. In some embodiments, the vertical support 32 may have an upper extension 54 extending transversely (e.g., in the direction of the Z-axis) towards the front of the vertical support unit 32 and configured to engage the upper instrument coupling assembly 34. In some embodiments, the vertical support 32 further includes a front vertical slide track 56 configured to slidingly engage the vertical slide member 142 of the scanning laser assembly 38 and at least one side vertical guide rail 58 configured to slidingly engage the adjustable base unit 80 of the lower instrument coupling assembly 36.

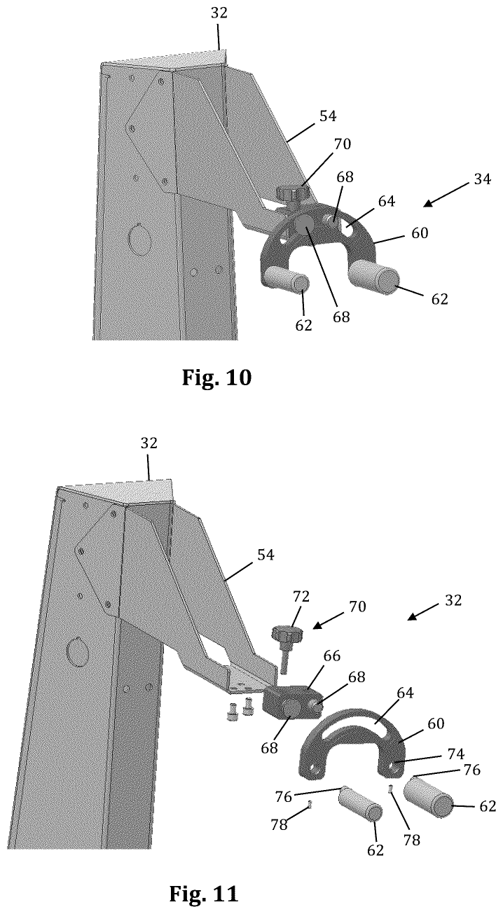

FIGS. 10-11 illustrate an example of an upper instrument coupling assembly 34 forming part of the musical instrument holder 12, according to some embodiments. In some embodiments, the upper instrument coupling assembly 34 is coupled to the upper extension 54 of the vertical support unit 32 and comprises a position-adjustable member 60 having instrument contact elements 62 spaced apart and configured to engage a distal portion of a stringed musical instrument 2, for example including but not limited to a guitar headstock. In some embodiments, the position-adjustable member 60 comprises a curved aperture 64 and is coupled to a base member 66 having one or more guide pins 68 extending therefrom, the one or more guide pins 68 configured to extend through the curved aperture 64 such that the position-adjustable member 60 can controllably pivot about the one or more guide pins 68. In some embodiments, the base member 66 further includes a locking element 70 including a knob 72 that facilitates rotation of the locking element 70 by a user to selectively lock and unlock the upper instrument coupling assembly 34 in a desired orientation to securely hold the instrument 2. In some embodiments, the contact elements 62 comprise cylindrical members rotatably coupled to receiving apertures 74 formed in the position-adjustable member 60 by posts 76 that may be offset from a central longitudinal axis of the cylinders so that the distance between the contact elements 62 may be enlarged or reduced by adjusting the rotational orientation of the contact elements 62. In some embodiments, a plurality of contact elements 62 having different sizes (and/or shapes) may be provided to accommodate a variety of instrument sizes and types that may be used with the instrument scanner system 10. In some embodiments, the upper instrument coupling assembly 34 further comprises fixation elements 78 configured to engage the posts 76 within the receiving apertures 74 to hold the contact elements 62 in the desired orientation. In some embodiments, the fixation elements 78 may be loosened or unlocked to enable rotation and/or removal/replacement of one or both contact elements 72.

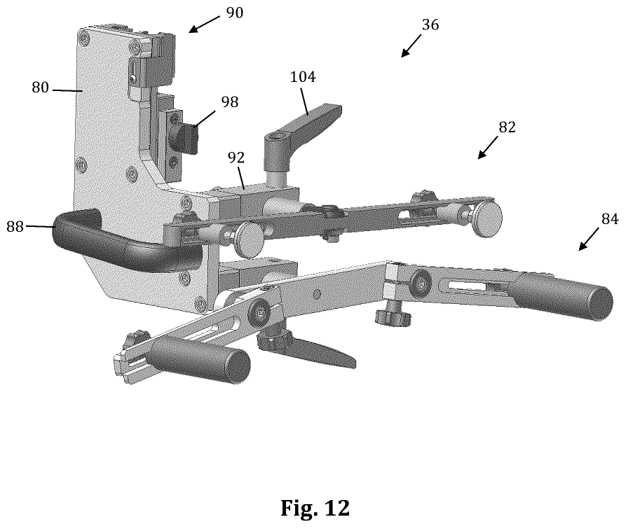

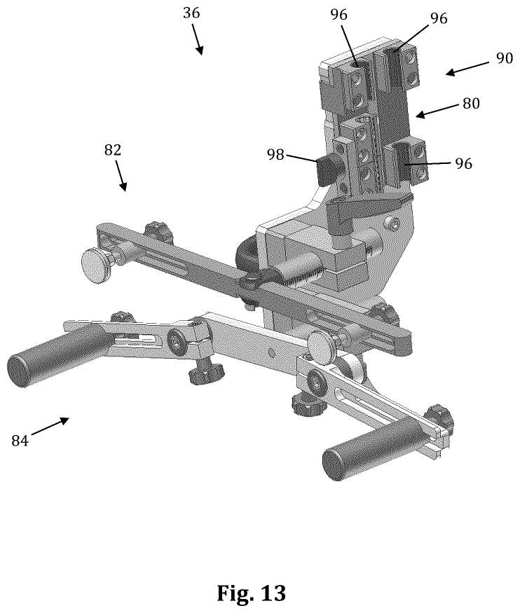

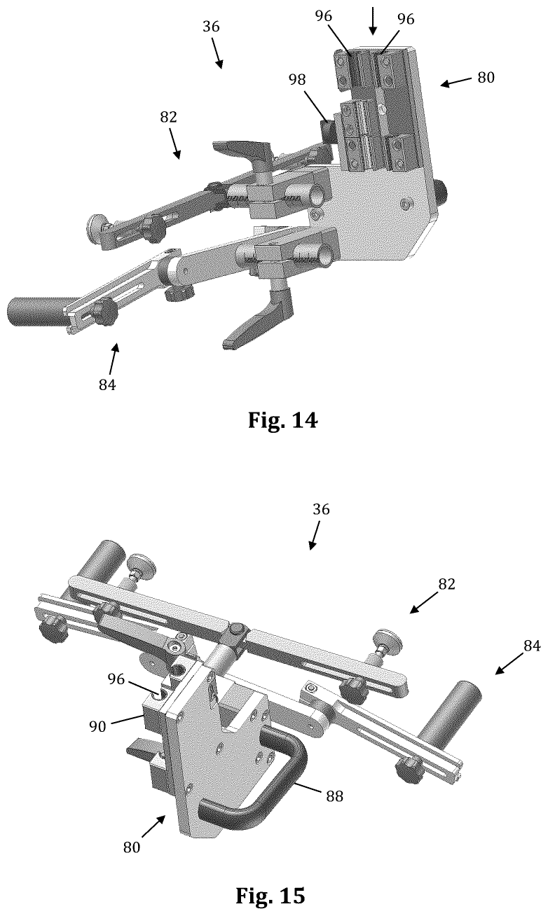

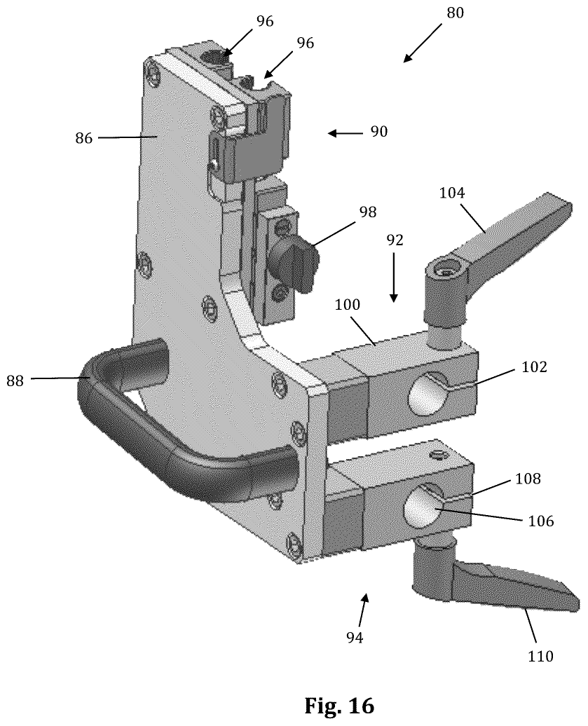

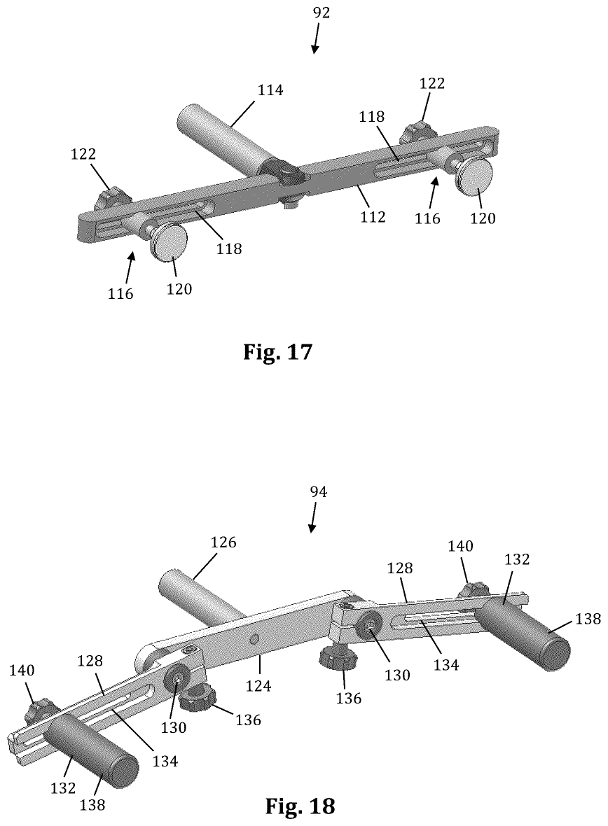

FIGS. 12-18 illustrate an example of a lower instrument coupling assembly 36 forming part of the musical instrument holder 12, according to some embodiments. In some embodiments, the lower instrument coupling assembly 36 comprises an adjustable base unit 80, a front body engagement assembly 82, and bottom body engagement assembly 84.

In some embodiments, the adjustable base unit 80 is slidably coupled with the side vertical guide rails 58 of the vertical support unit 32. By way of example, the adjustable base unit 80 may comprise a base plate 86 having a handle 88 attached to one side of the base plate 86 and one or more guide members 90, a front engagement assembly connector 92, and a bottom engagement assembly connector 94 positioned on and/or extending from the opposite side of the base plate 86. In some embodiments, the one or more guide members 90 each have a vertically oriented cylindrical channel 96 formed therein and configured to slidably engage the one or more side vertical guide rails 56 of the vertical support unit 32. In some embodiments, a locking element 98 interacts with the guide member 90 and is rotatable by a user to lock the base unit 80 in a desired vertical position along the vertical support unit 32. In some embodiments, the vertical position of the base unit 80 may be adjusted by first rotating the locking element 98 from a locked position to an unlocked position, and then using the handle 88 to raise or lower the base unit 80 as desired. When the desired vertical positioning is achieved, the locking element 98 may be rotated from an unlocked position to a locked position to secure the base unit 80 in place.

In some embodiments, the front engagement assembly connector 92 comprises an aperture 100 configured to receive the post 114 of the front body engagement assembly 82 therein, a split end 102, and an adjustment lever 104 actuatable to selectively lock and unlock the post 114 within the aperture 100 by applying or removing a compressive force to the split end 102. Similarly, in some embodiments, the bottom engagement assembly connector 94 comprises an aperture 106 configured to receive the post 126 of the bottom body engagement assembly 84 therein, a split end 108, and an adjustment lever 110 actuatable to selectively lock and unlock the post 126 within the aperture 106 by applying or removing a compressive force to the split end 108.

In some embodiments, the front body engagement assembly 92 comprises a crossbar 112 coupled with a post 114 and a plurality of instrument engagement elements 116 slidably coupled to the crossbar 112. In some embodiments, the crossbar 112 includes a plurality of elongated slots 118 configured to slidably receive a portion of the instrument engagement elements 116 therein such that the instrument engagement elements 116 may by adjusted medially or laterally to adjust to the size of the coupled instrument 2. In some embodiments, the post 114 extends perpendicularly from the crossbar 112 and is configured to translate within the aperture 100 of the front engagement assembly connector 92 along a Z-axis to facilitate front-back depth adjustment of the front body engagement assembly 92 to ensure proper positioning with respect to the coupled musical instrument 2. In some embodiments, the instrument engagement elements 116 may include an interface portion 120 configured to interface with a front surface of the instrument 2 (e.g., a front panel of a guitar) and a locking element 122 that is rotatable to lock the instrument engagement element 116 in a desired position or unlock the instrument engagement element 116 so that it may be moved to a desired position.

In some embodiments, the bottom body engagement assembly 94 comprises a bottom crossbar 124 coupled with a post 126 and a pair of bottom rest brackets 128 that are pivotally connected to each end of the crossbar 124 by a pivot pin 130. By way of example, the bottom body engagement assembly 94 further comprises a plurality of instrument engagement elements 132 slidably connected to the bottom rest brackets 128. In some embodiments, the post 126 extends perpendicularly from the crossbar 124 and is configured to translate within the aperture 106 of the bottom engagement assembly connector 94 along a Z-axis to facilitate front-back depth adjustment of the bottom body engagement assembly 94 to ensure proper positioning with respect to the coupled musical instrument 2. In some embodiments, each bottom rest bracket 128 comprises an elongated slot 134 configured to slidably receive a portion of the instrument engagement elements 132 therein such that the instrument engagement elements 132 may be adjusted medially or laterally to adjust to the size of the coupled instrument 2. In some embodiments, the pivot position of the bottom rest brackets 128 relative to the crossbar 124 may be selectively locked (and/or unlocked) by way of rotatable locking elements 136 that are actuatable to apply (e.g., to lock) or release (e.g., to unlock) compression on the pivot pin 130. In some embodiments, the instrument engagement elements 132 may include an interface portion 138 configured to interface with a bottom surface of the instrument 2 and a locking element 140 that is rotatable to lock the instrument engagement element 132 in a desired position or unlock the instrument engagement element 132 so that it may be moved to a desired position.

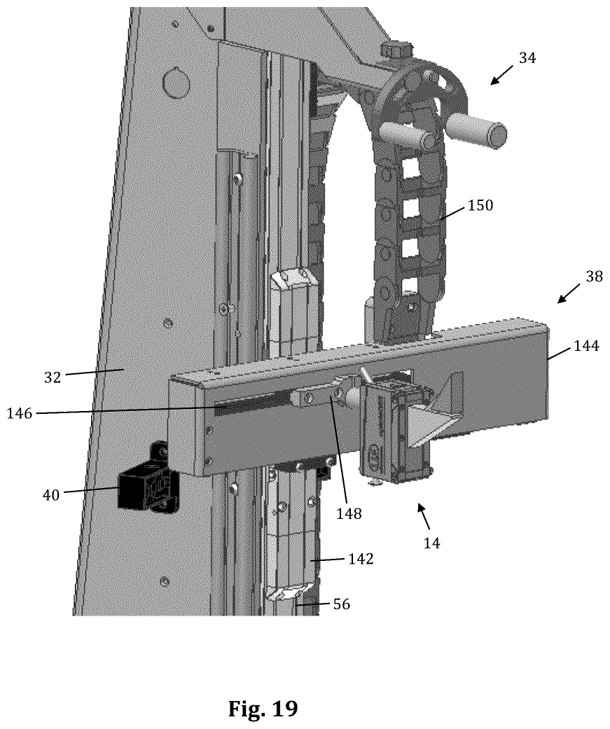

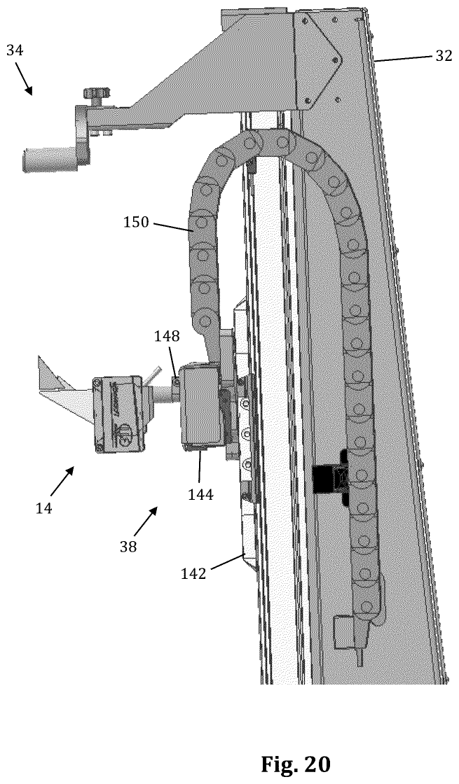

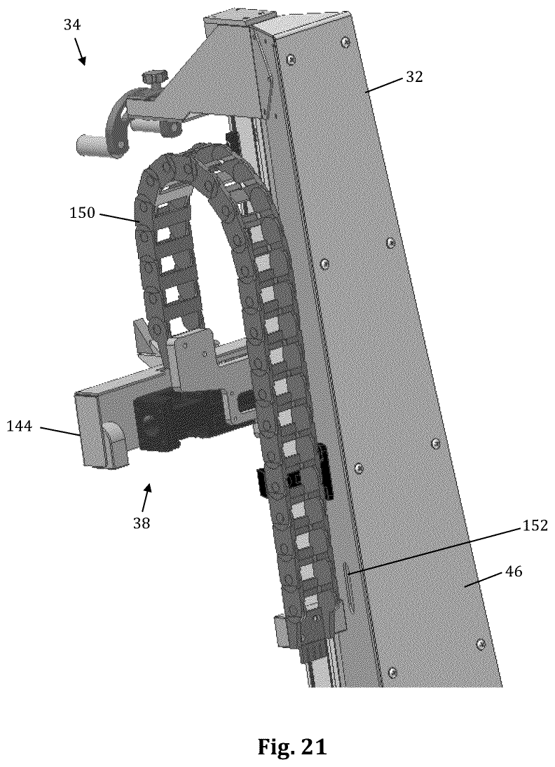

FIGS. 19-21 illustrate an example of a scanning laser assembly 38 forming part of the musical instrument scanning system 10 according to some embodiments. By way of example, in some embodiments, the scanning laser assembly 38 comprises a vertical slide member 142, a transverse housing 144, and the scanner 14. By way of example only, the vertical slide member 142 may be configured to translate along the front vertical slide track 56 of the vertical support member 32. In some embodiments, the transverse housing 144 is rigidly coupled to the vertical slide member 142. In some embodiments, the transverse housing 144 includes an elongated transverse slot 146 formed therein and configured to slidably receive a portion of the slidable coupler 148 of the scanner 14 therein to enable horizontal translation of the scanner 14.

By way of example, the vertical slide member 142 and the slidable coupler 148 facilitate vertical and horizontal movement of the scanner 14 to position the scanner 14 over various parts of the musical instrument 2.

In some embodiments, the scanner 14 comprises a high-resolution laser scanner. In some embodiments, the scanner 14 may be equipped with a MICRO-EPSILON optoNCDT 1420 semiconductor laser module that operates at a wavelength of 670 nm (visible/red) and falls within laser class 2. By way of example, the maximum optical power of the laser is ≤1 mW, and it operates in pulsed mode, with pulse frequencies that depend on the adjusted measuring rate (0.25 to 8 kHz). The pulse duration varies based on the measuring rate and the reflectivity of the target, ranging from 0.3 to 3999.6 μs. By way of example, the optoNCDT 1420 system is designed for industrial and laboratory applications, specifically for measuring displacement, distance, position, and thickness, as well as for in-process quality control and dimensional testing.

By way of example, the MICRO-EPSILON optoNCDT 1420 industrial laser sensor used by the scanner 14 works using optical triangulation. In some embodiments, the sensor emits a modulated light point onto a target surface and reads the reflected light using a CMOS sensor at a specific angle. Inside the sensor, a signal processor calculates the distance from the light point on the object to the sensor itself. In some embodiments, the sensor module is mounted on an x-axis linear guideway system (e.g., the transvers housing 144) powered by a precise stepper motor.

In some embodiments, the musical instrument holder 12 may further include a cable drag chain 150 extending between the transverse housing 144 and a side aperture 152 of the vertical support member 32 to protect cable running between the scanner 14 and the electronics cabinet 46.

A general use scenario is as follows. First, a user mounts the instrument 2 to the instrument holder 12 and activates the software app 20 on the computing device 16. Next, the user inputs instrument-specific data (e.g., including but not limited to brand, model, serial number, customer preference information, etc.) into the software. By way of example, this step may be accomplished by scanning a bar code or QR code, using a RFID reader, or inputting manually. The user then directs the computer 16 to scan the instrument 2 to collect certain measurement data (e.g., heat map of the fret plane, action at the first and/or twelfth frets, relief measurement, etc.). The user then evaluates a resulting output of this scan displayed on a display unit of the computing device, and then determines whether the instrument may be advanced to its next destination, sent for repair, or returned to the vendor. Then the user would repeat the process after any repairs are completed. In some embodiments, depending on any needed repairs, the entire process could take as little 2 or 3 minutes to complete.

Specific implementing features and example workflows will now be described in more detail. As in initial step, the scanner 14 must have data communication with the computer 16. This may be accomplished by way of a wired (e.g., ethernet) or a wireless (e.g., WiFi, Bluetooth, Internet, etc.) connection. Preferably, the data communication is by way of a wireless Internet connection. In some embodiments, the musical instrument scanning system 10 may include Internet-specific functionality, including but not limited to automatic error reporting, real-time debugging, interactive online support, cloud-based data backup and recovery, software updates, add-ons and hotfixes, access to database extensions, and/or access to online string sets and tunings. In some embodiments, these features may be achieved by way of creating a virtual networking account with the software service provider, for example by providing information such as user contact information and scanner serial number, etc.

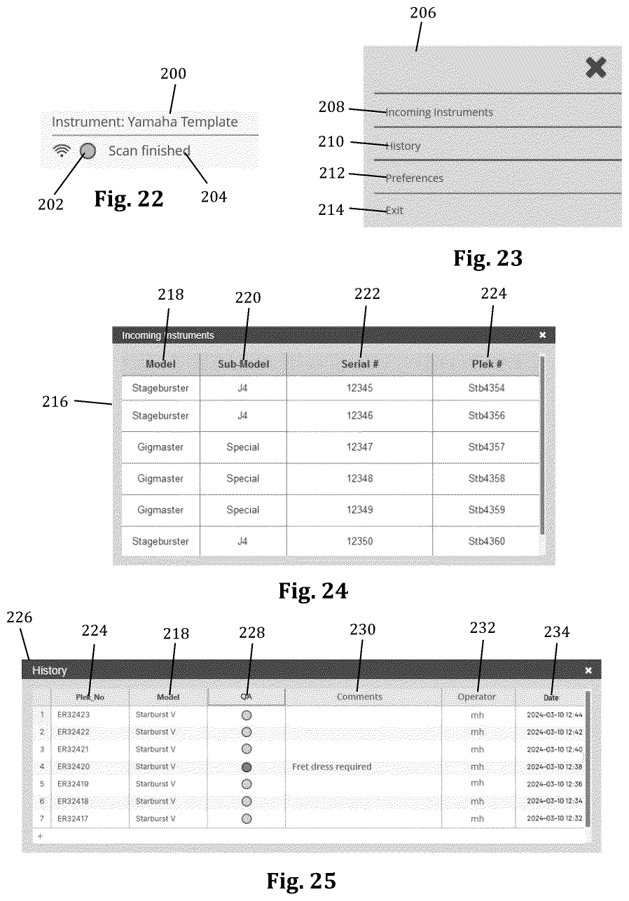

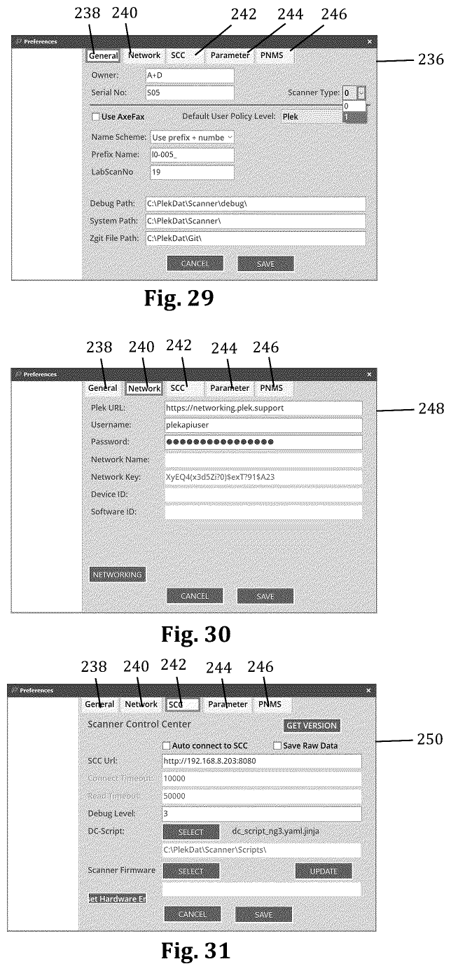

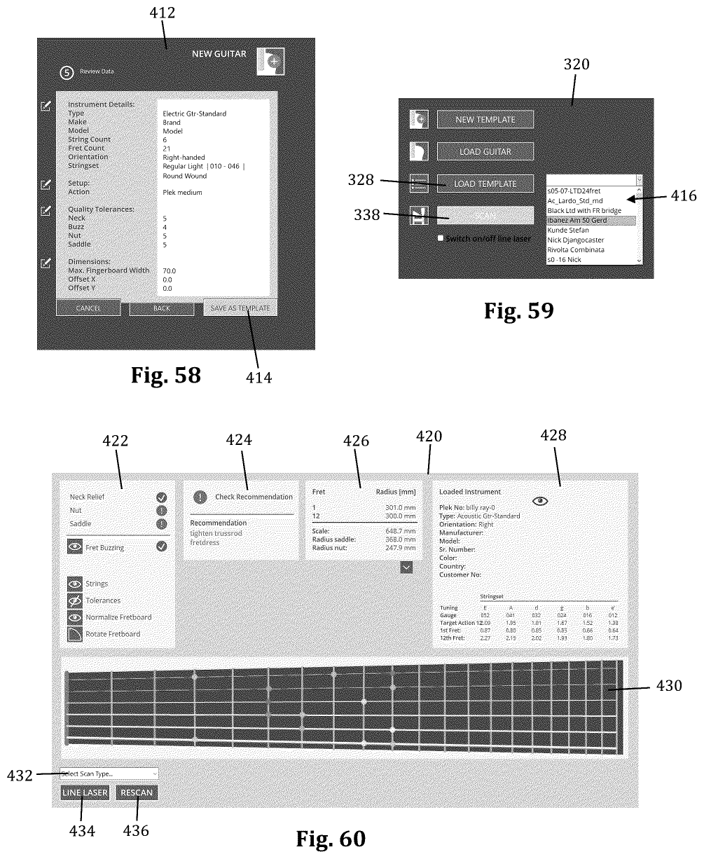

By way of example only, FIGS. 22-73 illustrate example screen shots and/or interactive portions of screen shots illustrating interactive elements of the software app 20 that may be presented by the computer 16 to a user. For example, FIGS. 22-34 illustrate sample interactive elements of a status bar that the computer 16 may present to a user on a main user interface screen. In some embodiments, as illustrated in FIG. 22, the status bar may include the template name 200 of the currently loaded instrument template, a network status icon 202 (e.g., in which a green circle may indicate connected status and a red circle may indicate disconnected status), and a scan status identifier 204. In some embodiments, the status bar may also include a “hamburger” icon (for example) or similar icon which prompts the computer 16 to display a pull-down menu 206 upon activation by a user (e.g., by clicking or tapping on the icon). As shown by way of example in FIG. 23, in some embodiments, the pull-down menu 206 may include selectable options such as “Incoming Instruments” 208, “History” 210, “Preferences” 212, and “Exit” 214. In some embodiments, selecting the “Incoming Instruments” 208 option prompts the computer 16 to display an “Incoming Instrument” display screen 216 (pop-up or otherwise) that may display information pertaining to known instruments incoming for repair/analysis, including but not limited to (and by way of example only) model name 218, sub-model 220, serial number 222, and system reference number 224 (e.g., Plek no.), as shown by way of example in FIG. 24. In some embodiments, selecting the “History” 210 option prompts the computer 16 to display a “History” display screen 226 that may display historical information pertaining to instruments previously scanned, including but not limited to (and by way of example only) a system reference number 224, model name 218, QA status 228 (e.g., color coded such as green for pass, red for fail), Comments 230 (if any, for example to indicate reason for failed QA status), Operator name or initials 232, and service date 234, as shown by way of example in FIG. 25.

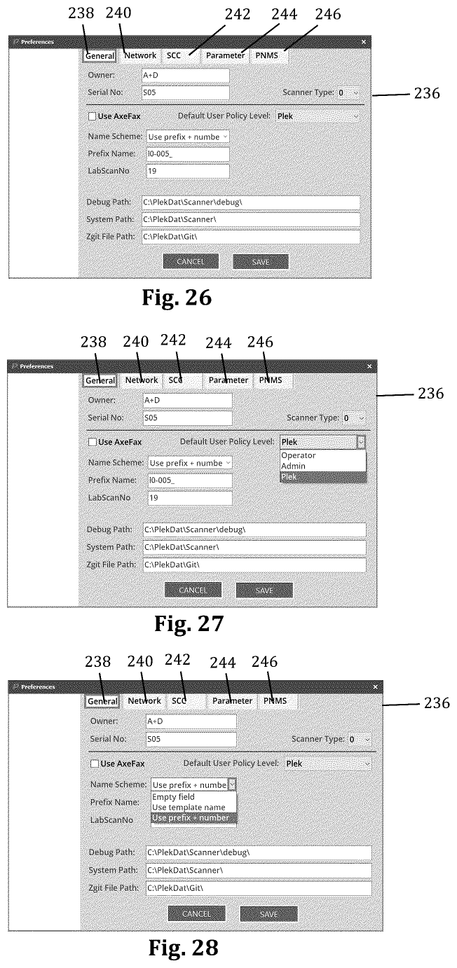

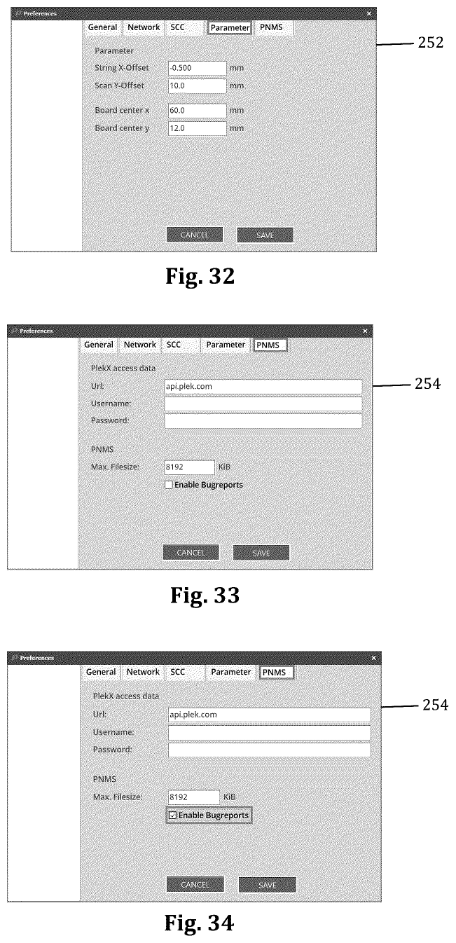

In some embodiments, selecting the “Preferences” 212 option prompts the computer 16 to display a “Preferences” screen (e.g., “general preferences”) 236 that enables a user to input or edit various preferences, as shown by way of example in FIGS. 26-34. In some embodiments, the “Preferences” screen 236 includes selectable options to direct the user to input/edit user preferences related to specific features, including “General” 238 (e.g., presented by the computer 16 by default upon selecting the “Preferences” option 212), “Network” 240, “SCC” 242, “Parameter” 244, and “PNMS” 246. For example, options presented to the user to input/edit on the “general preferences” screen 236 may include owner information, scanner serial number, scanner type, default user policy level, name scheme, prefix name, LabScan No., Debug path, System path, and Zgit file path, as shown by way of example in FIGS. 26-29. By way of example, selecting the “Network” 240 option prompts the computer 16 to present a network preferences interface screen or window 248, shown by way of example in FIG. 30. For example, options presented to the user to input/edit on the “Network” preferences screen 248 may include Plek URL, Username, Password, Network Name, Network Key, Device ID, and/or Software ID. By way of example, selecting the “SCC” 242 option prompts the computer 16 to present a “Scanner Control Center” preferences interface screen or window 250, shown by way of example in FIG. 31. For example, options presented to the user to input/edit on the “Scanner Control Center” preferences screen 250 may include: SCC Url, Connect Timeout, Read Timeout, Debug Level, DC Script, Scanner Firmware, Auto connect to SCC (e.g., via checkbox), and Save raw data (e.g., via checkbox). By way of example, selecting the “Parameter” 244 option prompts the computer 16 to present a “Parameter” preferences interface screen or window 252, shown by way of example in FIG. 32. For example, options presented to the user to input/edit on the “Parameter” preferences screen 252 may include String X-Offset, Scan Y-Offset, Board center x, and Board center y. By way of example, selecting the “PNMS” 246 option prompts the computer 16 to present a “PNMS” (e.g., Plek Network Monitoring System) preferences interface screen or window 254, shown by way of example in FIGS. 33-34. For example, options presented to the user to input/edit on the “PNMS” preferences screen 252 may include URL, Username, and Password (e.g., under PlekX access data), Maximum file size, and Enable bug reports (e.g., via checkbox).

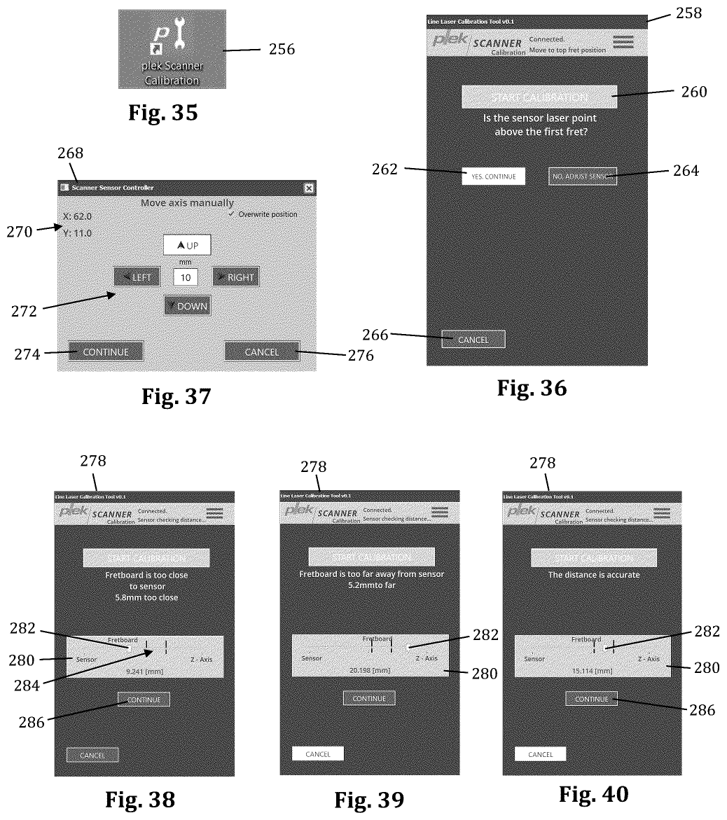

By way of example only, FIGS. 35-46 illustrate a sample workflow that the computer 16 may present to a user and the user may follow to calibrate the scanner 14 (e.g., “sample calibration workflow”), according to some embodiments. A first step in the sample calibration workflow is to insert a stringed musical instrument 2 (e.g., guitar) into musical instrument holder 12 such that a base of the instrument is resting in the lower instrument coupling assembly 36 and an upper portion (e.g., headstock) is resting in the upper instrument coupling assembly 34. A next step in the sample calibration workflow is to locate and click on the “Plek Scanner Calibration” software icon 256 on the main desktop interface screen, shown by way of example in FIG. 35. Activating this icon prompts the computer 16 to present the user with a “Start Calibration” interface screen 258, shown by way of example in FIG. 36. By way of example, the “Start Calibration” interface screen 258 may include a “Start Calibration” button 260, which when pressed or clicked on by the user will prompt the computer to ask the user to verify if the laser point is properly aligned above the first fret by checking that the laser point is centered on the fingerboard (in the X direction) and between the net and first fret (in the Y direction). If the user verifies this to be true, then the user clicks or presses on the “Continue” button 262. If not, then the user would click or press on the “No, Adjust Sensor” button 264. To cancel the calibration process, the user would click or press on the “Cancel” button 266.

If the user verified that the sensor was not aligned in the previous step and as a result pressed or clicked on the “No, Adjust Sensor” button 264, then the computer 16 presents to the user a Scanner Sensor Controller window 268 in which the user may manually move the laser to properly position the laser scanner 14. By way of example, the Scanner Sensor Controller Window 268 may include an X-Y position indicator 270 and a position adjuster 272 (e.g., including up, down, left, right arrow buttons and a window to input the distance (in millimeters) to move the laser with each click). The user then enters the distance to move the laser and uses the arrow buttons to instruct the computer 16 to move the laser in response the user's inputs and such that the laser is aligned with the center of the fretboard in the X Offset and between the nut and the first fret in the Y Offset. If satisfied with the adjusted position of the laser, the user then clicks or presses on the “Continue” button 274. Alternatively, the user may click or press on the “Cancel” button 276 which prompts the computer 16 to cancel the calibration process and return the user to the main software interface screen.

Once the laser is properly aligned above the first fret, a next step in the sample calibration workflow is to check the Z-distance range of the fretboard relative to the laser scanner 14. Upon clicking or pressing the “Continue” button 276, the computer 16 will present a distance calibration window 278 with a Z-position indicator 280 having a slider 282 representing the fretboard's surface, as shown by way of example in FIGS. 38-40. In some embodiments, the slider 282 moves left or right based on physical movement of the instrument 2 in the instrument holder 12. Thus, the user may adjust the instrument by hand to obtain the correct position. To accomplish this, the user may ensure the slider 282 is within a correct range indicator 284 (e.g., two vertical lines, shaded or colored box/area, etc.) indicating the correct distance range (Z-range) of the fretboard from a distance sensor of the scanner 14. In some embodiments, if the fretboard is positioned too close to the sensor, the slider 282 will appear to the left of the correct range indicator 284 and the computer 16 may display a message such as “Fretboard is too close to sensor” (e.g., “[X] mm too close”), as shown by way of example in FIG. 38. In some embodiments, if the fretboard is positioned too far away from the sensor, the slider 282 will appear to the right of the correct range indicator 284 and the computer 16 may display a message such as “Fretboard is too far from the sensor” (e.g., “[X] mm too far”), as shown by way of example in FIG. 39. In some embodiments, if the fretboard is positioned within the correct distance range from the sensor, the slider 282 will appear within the correct distance indicator 284 and the computer 16 may display a message such as “The distance is accurate.” If the distance is accurate, the user may click the Continue button 286. If the distance is outside of the correct range, then the user would manually adjust the position of the instrument for example by adjusting the upper instrument coupling assembly 34 and/or the lower instrument coupling assembly 36 as described above until the correct Z-distance is established.

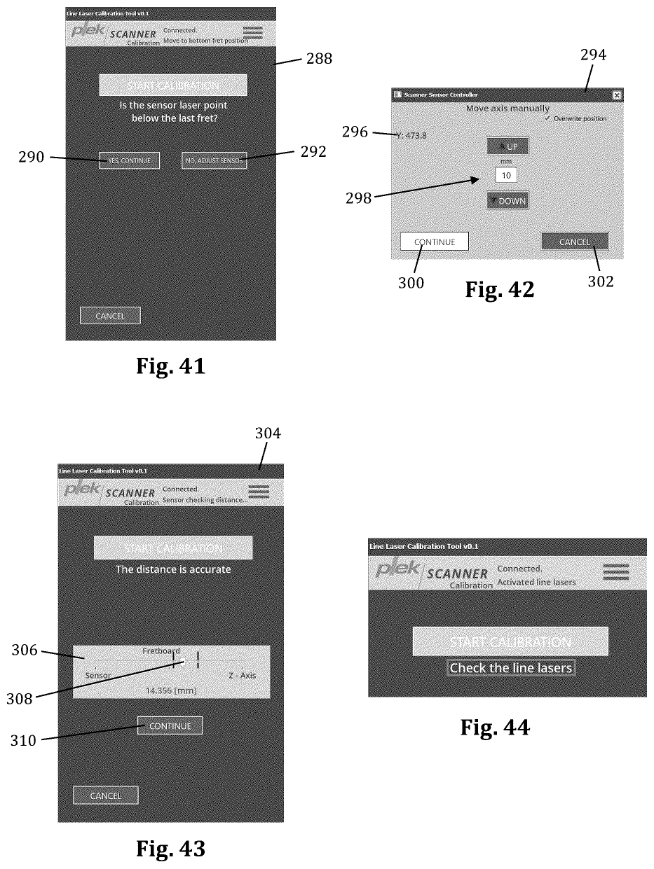

Once the correct Z-distance has been obtained or verified, the computer 16 will move the sensor laser point below the last fret and. Upon clicking the “Continue” button 286 on the distance calibration window 278, the computer 16 will present the user with a verification window 288 including a prompt asking the user (for example) “Is the sensor laser point below the last fret?” as shown by way of example in FIG. 41. In response to this prompt, the user may ensure the laser point rests on the fretboard below the last fret, and/or verify that the laser point is centered on the fretboard by manually moving the instrument in the X direction as needed. If the user verifies that the laser pointer rests on the fretboard before the last fret, the user may press or click on the “continue” button 290. If not, then the user may click on the “No, adjust sensor” button 292.

If the user verified that the sensor was not aligned in the previous step and as a result pressed or clicked on the “No, Adjust Sensor” button 292, then as a next step the computer 16 presents to the user a Scanner Sensor Controller window 294 in which the user may manually move the laser to properly position the laser scanner 14, as shown by way of example in FIG. 42. By way of example, the Scanner Sensor Controller Window 294 may include a Y position indicator 296 and a position adjuster 298 (e.g., including up and down arrow buttons and a window to input the distance (in millimeters) to move the laser with each click). The user then enters the distance to move the laser and uses the arrow buttons to instruct the computer 16 to move the laser in response the user's inputs and such that the laser is aligned on the fretboard below the last fret. If satisfied with the adjusted position of the laser, the user then clicks or presses on the “Continue” button 300. Alternatively, the user may click or press on the “Cancel” button 302 which prompts the computer 16 to cancel the calibration process and return the user to the main software interface screen.

Once the laser is properly aligned below the last fret, a next step in the sample calibration workflow is to re-check the Z-distance range of the fretboard relative to the laser scanner 14. Upon clicking or pressing the “Continue” button 300, the computer 16 will present a second distance calibration window 304 with a Z-position indicator 306 having a slider 308 representing the fretboard's surface, as shown by way of example in FIG. 43. Operation of and interaction with this second distance calibration window 304 is the same as the operation of and interaction with the distance calibration window 278 described above with reference to FIGS. 38-40. If the distance is accurate, the user may click or press on the Continue button 310.

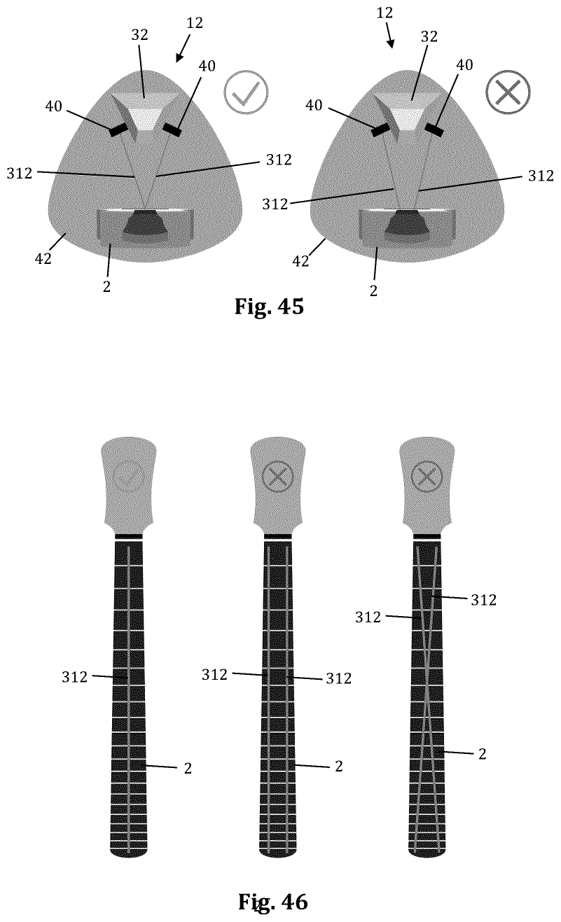

Once the Z-distance has been verified for a second time, the final step in the sample calibration workflow is to align the line lasers 40. Upon clicking or pressing on the Continue button 310, the computer 16 may display a prompt such as “Check the line lasers” as shown by way of example in FIG. 44. In some embodiments, the scanning system 10 has two line lasers 40, one mounted on the each side of the vertical support assembly 32 as described above and as shown in FIG. 45. In some embodiments, the line lasers 40 project long vertical beams 312 onto the fingerboard (or “fretboard”) surface of the instrument 2. In this step, the user may manually adjust the position of both line lasers 40 so that the vertical beams 312 beams overlap at the center of the fingerboard such that the vertical beams 312 cover overlap completely. In some embodiments, the line lasers 40 can be moved left to right (or right to left) and can also be rotated around an axis. Once the lasers are properly aligned, the user should not touch them again. This setup ensures that different instruments can be aligned without the need to readjust the Z-range each time. By way of example, the left image in FIG. 45 illustrates a proper alignment of the vertical beams 312 while the right-side image illustrates an example of an improper alignment. Similarly, the left image in FIG. 46 illustrates a proper alignment of the vertical beams 312 while the center and right images illustrate examples of improper alignments.

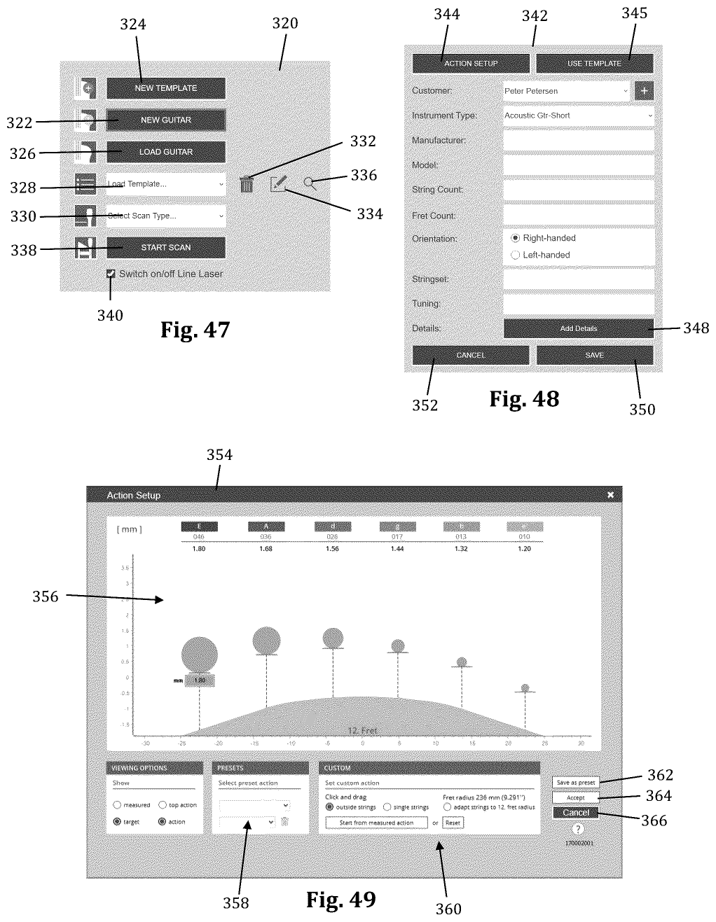

FIG. 47 illustrates an example of a main user interface screen 320 that the computer 16 may present to the user on a display screen of the user's computing device 16 upon the user opening the software app 20. By way of example, the main user interface screen 320 may include a “New Instrument” (or “New Guitar”) button 322, a “New Template” button 324, a “Load Guitar” button 326, a “Load Template” button or pulldown menu 328 with associated trash icon 330, edit icon 332, and search icon 334, a “Select Scan Type” button or pulldown menu 336, a “Start Scan” button 338, and a “Switch on/off Line Laser” button or checkbox 340. In some embodiments, pressing or clicking on the “New Instrument” button 322 activates a new instrument file workflow, an example of which is described in further detail below. In some embodiments, pressing or clicking on the “New Template” button 324 activates a new template workflow, an example of which is described in further detail below. In some embodiments, pressing or clicking on the “Load Guitar” button 326 enables a user to select a previously saved instrument file. In some embodiments, pressing or clicking on the “Load Template” button 328 enables the user to select a previously saved template file. In some embodiments, pressing or clicking on the trash icon 330 enables a user to delete a previously saved template. In some embodiments, pressing or clicking on the edit icon 332 enables a user to edit a previously saved template. In some embodiments, toggling the “Switch on/off Line Laser” button or checkbox 340 prompts the computer 16 to turn the line lasers 40 on or off.

By way of example only, FIGS. 48-51 illustrate a sample workflow that the computer 16 may present to a user and the user may follow to create a new instrument file in the software app 20 (e.g., “sample new instrument file workflow”), according to some embodiments. As a first step in the sample new instrument file workflow, the user presses or clicks on the “New Instrument” (e.g., “New Guitar”) button 322 on the main user interface screen 320 as shown in FIG. 47. Activating this button will prompt the computer 16 to present the user with a Basic Details window 342 (e.g., FIG. 48) which enables the user to input basic details about the new instrument into the software app 20, including but not limited to customer name, instrument type, instrument manufacturer, instrument model, string count, fret count, orientation (e.g., handedness), desired string set (e.g., to be selected from a pulldown menu), desired tuning. By way of example, the Basic Details window 342 may further include an Action Setup button 344, a Use Template button 346, an Add Details button 348, a Save button 350, and a Cancel button 352.

In some embodiments, clicking or pressing on the Action Setup button 344 prompts the computer 16 to display the Action Setup window 354 (e.g., FIG. 49). In some embodiments, the Action Setup window 354 displays the user's selected string set (selected on previous window) 356 and enables the user to select a preset action 358, set a custom action 360, save the configuration as a preset by pressing or clicking a Save Preset button 362, accept the selected configuration (without saving as a preset) by pressing or clicking an Accept button 364, or abandon the action setup window by pressing or clicking a Cancel button 366.

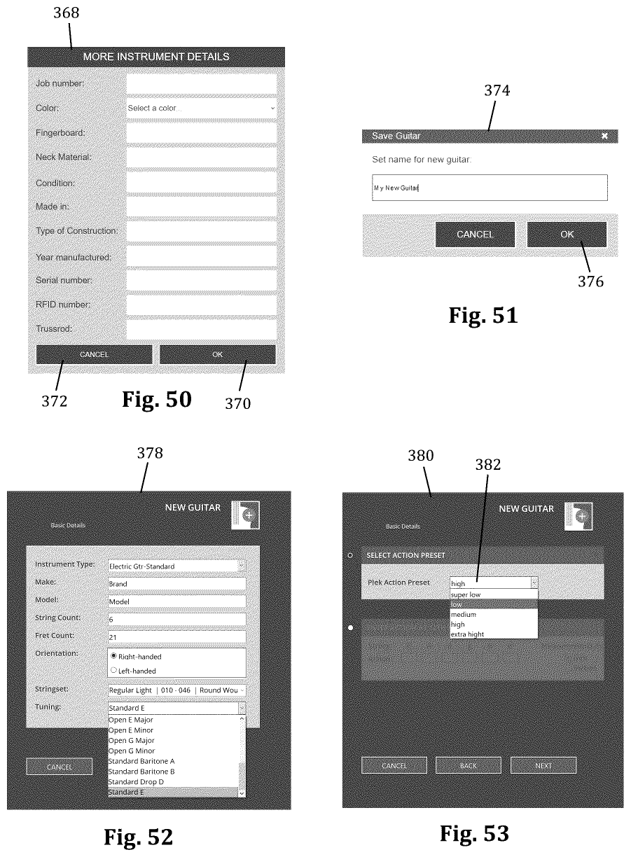

In some embodiments, clicking or pressing on the Add Details button 348 prompts the computer 16 to display to the user a More Instrument Details window 368 (e.g., FIG. 50), in which the user may input more details pertaining to the new instrument, including but not limited to (and by way of example only) color, fretboard and neck material, condition, country of origin, type of construction, production year, serial number, radio-frequency identification (RFID) number, and/or truss rod access. In some embodiments, the user may click or press on an OK or Save button 370 to return to the Basic Details window 342 after saving the entered information or the Cancel button 372 to return to the Basic Details window 342 after saving any information. If the user is satisfied with the entered details on the Basic Details window 342 and/or the More Instrument Details window 368, the user may then press or click on the save button 350. This action prompts the computer 16 to display a Save Instrument window 374, which includes a text entry box and prompt from the computer 16 to enter a name for the new instrument file, as shown by way of example in FIG. 51. Once this has been entered, the user may click on the OK or Save button 376. The instrument file has now been created and can be accessed via the Load Guitar option 326 on the main screen 320.

By way of example only, FIGS. 52-58 illustrate a sample workflow that the computer 16 may present to a user and the user may follow to create a new template file in the software app 20 (e.g., “sample new template workflow”), according to some embodiments. As a first step in the sample new template file workflow, the user presses or clicks on the “New Template” button 324 on the main user interface screen 320 as shown in FIG. 47. Activating this button will prompt the computer 16 to present the user with a Basic Details window 378 (e.g., FIG. 52) which enables the user to input basic details about the new template into the software app 20, including but not limited to customer name, instrument type, instrument manufacturer, instrument model, string count, fret count, orientation (e.g., handedness), desired string set (e.g., to be selected from a pulldown menu), desired tuning. By way of example, the Basic Details window 378 may further include a Next button and a Cancel button.

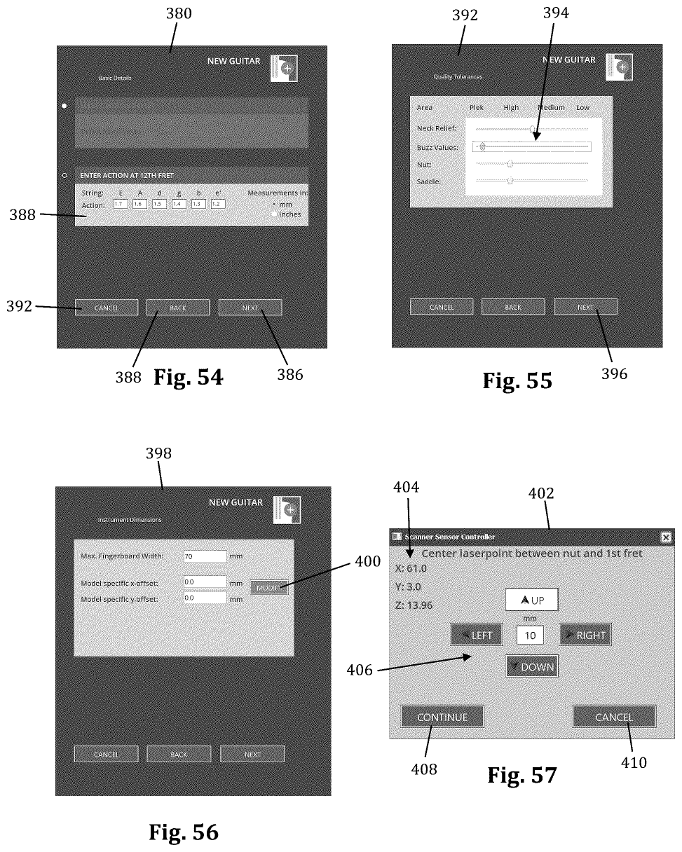

After entering the details, clicking or pressing on the Next button to prompt the computer to continue or cancel to abandon the process and return to the main user interface screen 320. Upon clicking or pressing the Next button, the computer 16 will present the user with an Action Setup window 380 (e.g., FIG. 53). On the Action Setup window 380, the user may select an Action Preset from an Action Preset drop-down menu 382 and enter custom actions in millimeters or inches for example in a customization section 384 (as shown in FIG. 54). Additionally, the user may click or press the Next button 386 to continue, Back button 388 to return to the previous window, or a Cancel button 390 to abandon the process.

Upon pressing or clicking the Next button 386, the computer 16 presents the user with a Quality Tolerances window 392, which includes a slide adjuster 394 that enables the user to customize the tolerance for individual measurements including but not limited to neck relief, buzz values, nut (slots depth), and/or saddle (height). In some embodiments, the target is derived from the specified string action and the selected string gauge. For example, shifting the slider towards the Plek setting makes the tolerance tighter (e.g., only results that align closely with the set target will be accepted as correct), and shifting the slider towards the Low setting makes the tolerance looser (e.g., increasing the maximum allowed deviation from the set target that can be accepted as correct). In some embodiments, once the user has adjusted the sliders to their desired positions, the user may click or press the Next button 396 to continue.

In some embodiments, clicking or pressing on the Next button 396 prompts the computer 16 to display an Instrument Dimensions window 398 to the user to ensure accurate readings by the laser scanner 14. In this window, the user may input the maximum fingerboard width and the specific X and Y offsets for the instrument type and model in the specified locations. In some embodiments, to verify the laser point's alignment, the user may click or press the Modify button 400 which prompts the computer 16 to present new scanner sensor window 402 to the user. By way of example, the scanner sensor controller window 402 may include an X-Y-Z position indicator 404 and a position adjuster 406 (e.g., including up, down, left, right arrow buttons and a window to input the distance (in millimeters) to move the laser with each click). The user then enters the distance to move the laser and uses the arrow buttons to instruct the computer 16 to move the laser in response the user's inputs and such that the laser is aligned with the center of the fretboard in the X Offset and between the nut and the first fret in the Y Offset. If satisfied with the adjusted position of the laser, the user then clicks or presses on the “Continue” button 408. Alternatively, the user may click or press on the “Cancel” button 410 which prompts the computer 16 to cancel the alignment process and return the user to the previous screen.

After clicking or pressing the Continue button 408, the computer 16 presents the user with a Review Data window 412 which enables the user to review the entered data before saving as a template (or cancelling the process). If the user is satisfied with the information presented, the user may click or press a Save as Template button 414. On the next window presented by the computer 16, the user may enter the name of the template and click OK. The template has now been created and can be accessed from the Load Template drop-down menu 328 on the main user interface screen 320.

An example method of scanning a musical instrument (e.g., a guitar) using the portable musical instrument scanning system 10 will now be described. In some embodiments, a first step in the method of scanning a musical instrument is to ensure the scanner 14 is properly calibrated before starting. For example, this may require following the sample calibration workflow described above. Once the scanner 14 has been properly calibrated, the next step in the method of scanning a musical instrument is to couple the instrument 2 to the instrument holder 12 as described above. With the line lasers 40 turned on, the user may then use the adjustment mechanisms of the upper instrument coupling assembly 34 and the lower instrument coupling assembly 36 to align the instrument 2 with the two line laser beams 312, ensuring that the line laser beams 312 overlap at the center of the instrument fretboard. This may require adjustment in an X-direction, a Y-direction, and/or a Z-direction. Optionally, the user may select a template file from a template list 416 that the computer 16 displays in response to the user clicking or pressing on the Load Template button 328 of the main user interface screen 320 (e.g. FIG. 59). Next, the user may click or press the “Scan” (or “Start Scan”) button 338 to activate the scanner and start the measurement process. In some embodiments, the computer 16 may prompt the user to enter a descriptive name for the scan (e.g., model number, serial number, or purpose such as “string action scan”). In some embodiments, if the name has been used before, the computer 16 will prompt the user to create a new name. In some embodiments, the computer may then prompt the user to enter additional text description if desired.

In some embodiments, after the file has been named and the additional description has been entered (or bypassed), the computer 16 will cause the scan to be performed. In some embodiments, the computer will cause the scanner 14 to first move above the first fret to find the positions of all the strings. Then, the computer 16 will cause the scanner 14 to move below the 12th fret to check the string positions there. This helps the scanner 14 determine the exact path of each string. Finally, the scanner 14 will move along each string to measure the positions of the frets underneath. In some embodiments, this information will be displayed graphically in the software. Once the scanning is completed, the computer 16 will display a dialogue box to alert the user that the scanning is complete. Clicking or pressing an OK or Next button prompts the computer 16 to present the scan results for viewing by the user.

In some embodiments, the computer 16 may display an icon menu enabling quick access to detailed, measured data, for example including but not limited to side view, string graph, scale and fret placement, action setup, and nut and saddle setup.

In some embodiments, the computer 16 may display to the user a scan overview window or screen 420, for example as shown in FIG. 60. By way of example, the scan overview window or screen 420 may include a diagnostic summary 422, a recommendation field 424, a radius and scale measurement field 426, an instrument details field 428, a buzz values graph 430, a scan type dropdown menu 432, line laser button 434, and a rescan button 436. In some embodiments, the diagnostic summary 422 highlights instrument issues in several categories, including but not limited to (and by way of example only neck relief, fret buzzing, and nut and saddle. In some embodiments, each issue has its own Status Icon to indicate status, for example a green check mark (indicating it is within tolerance) or a red exclamation mark (indicating it is out of tolerance). In some embodiments, the user can also hide or display individual elements of the overview by clicking or pressing on the View Icon (eye symbol) and rotate the Buzz Values Graph horizontally or vertically by clicking on the Rotate Fretboard icon (for example).

In some embodiments, the recommendation field 424 provides software-generated suggestions based on the scan results, such as Fret Dressing or Truss Rod Adjustment. In some embodiments, the radius and scale measurement section 426 displays the radius and scale measurements. In some embodiments, the user can toggle between inches and millimeters for the units of measurement. By way of example, the expanded view shows the measured radius at each fret. In some embodiments, the instrument details section 428 enables the user to view and input instrument specifications and/or upload an instrument photo. In some embodiments, the buzz values graph 430 displays the fingerboard with markers indicating potential buzz locations. In some embodiments, the user may select a scan type in the scan type dropdown 432 from options like Full Scan, Action Scan, Truss Rod Scan, or Fingerboard Scan. In some embodiments, the line laser button 434 activates the line lasers 40 as described above. In some embodiments, the rescan button 436 prompts the computer 16 to reinitiate the scan when pressed.

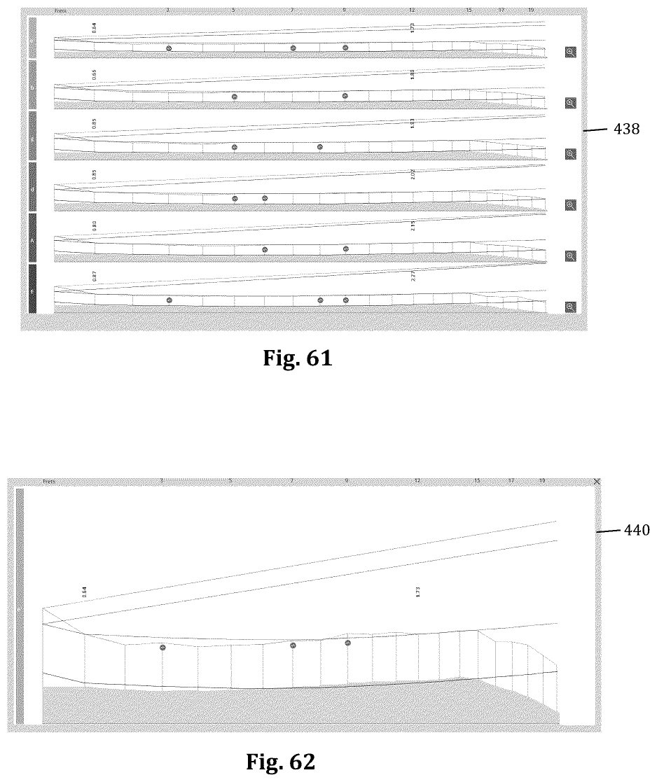

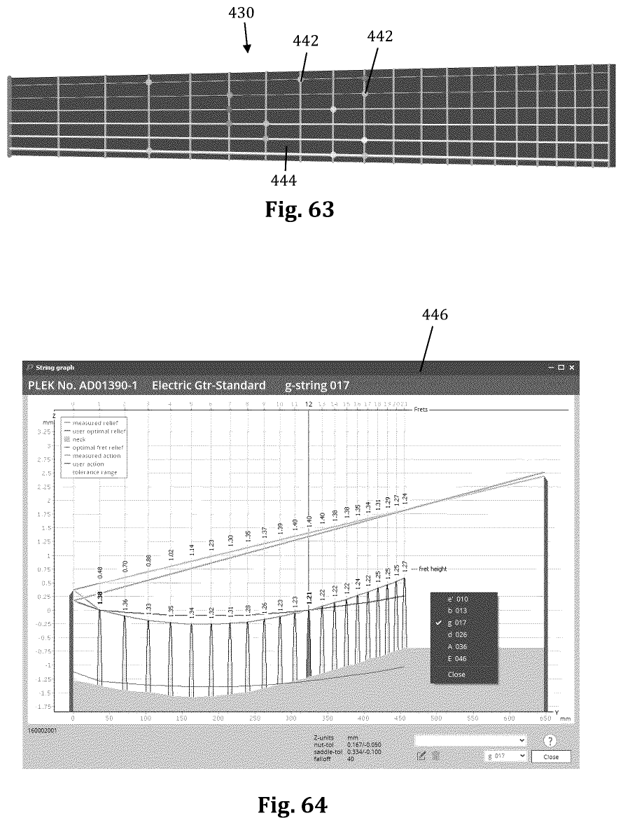

In some embodiments, the computer 16 may display to the user a side view scan 438 as shown by way of example in FIG. 61. By way of example, the side view scan 438 may include representation for all strings in the instrument. In some embodiments, the computer 16 may display to the user an alternative side view scan 440 as shown by way of example in FIG. 62. By way of example, the side view scan 440 depicts a single string.

In some embodiments, the computer 16 may display to the user a buzz values graph 430 as shown by way of example in FIG. 63. In some embodiments, the round markers 442 displayed on the fingerboard 444 indicate positions that may experience string buzz under the current setup. By way of example, the displayed values are influenced by the applied tolerance settings, with severity highlighted using an indicator. In some embodiments, the severity indicator may comprise color codes, for example with yellow indicating slight buzz issues, orange (for example) indicating moderate buzz issues, and red (for example) indicating serious buzz issues. In some embodiments, possible corrective actions for the identified buzzing issues may include but are not limited to truss rod adjustment, partial fret dressing, complete fret dressing, and/or adjustment of nut or saddle height.

In some embodiments, the musical instrument scanning system 10 may be configured to analyze the collected data and recommend an appropriate corrective action(s) based on the identified buzz values and overall instrument condition.

In some embodiments, the computer 16 may display to the user a string graph 446 as shown by way of example in FIG. 64. By way of example only, the string graph 446 displays a side view of the instrument, for example a guitar with the nut on the left and the saddle on the right. In some embodiments, the user can customize the string graph window 446 in the system preferences to control the level of detail shown. In some embodiments, the computer 16 may display to the user a graph for each individual string. In some embodiments, the user may activate this feature, by right-clicking or scroll inside of the string drop-down field to access a list of the instrument's strings.

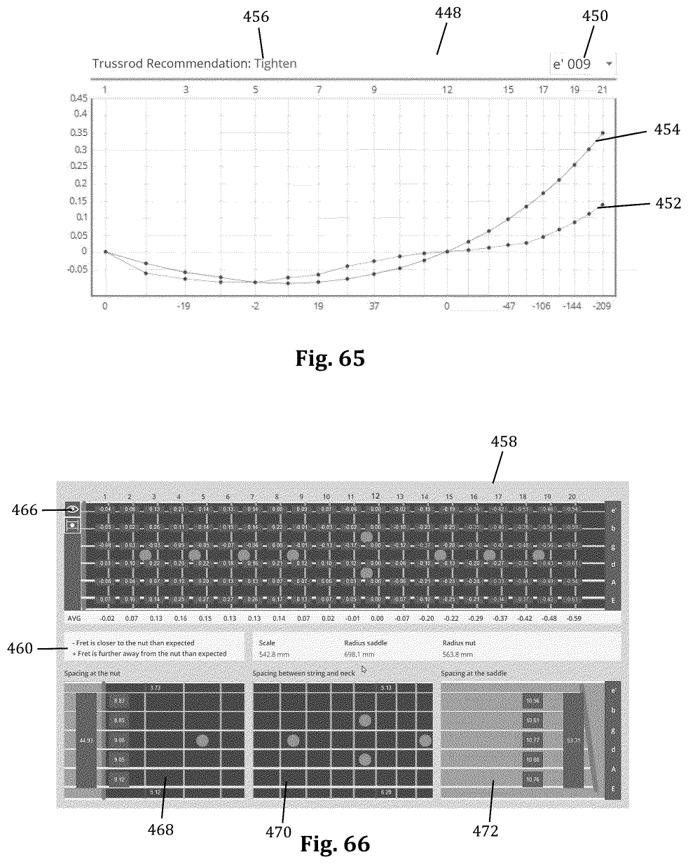

In some embodiments, the computer 16 may display to the user a truss rod scan 448 as shown by way of example in FIG. 65. By way of example, the truss rod scan graph 448 depicts the fingerboard relief under the selected string. In some embodiments, the user may toggle between selected strings by accessing the string dropdown menu 450, positioned for example in the upper right corner of the truss rod scan graph window 448. Ideally, the measured relief curve 452 (e.g., colored red) should be aligned with the target relief curve 454 (e.g., colored green). In some embodiments, the user may use this graph as a guide for truss rod adjustment. In some embodiments, the computer 16 may present to the user a truss rod recommendation 456 based upon analysis of the truss rod scan data. For example, if the tolerances are outside of predetermined accepted values, the computer 16 will present a truss rod recommendation 456 of either “tighten” or “loosen” depending upon which corrective action is necessary. When the measured relief curve 452 and target relief curve 454 overlap evenly, the computer 16 will present a truss rod recommendation 456 of “within tolerance”.

In some embodiments, the scanner 14 automatically measures the relief under the string closest to the center of the instrument (based on the number of strings, handedness, and tuning). In some embodiments, the selected string is displayed in the top right corner of the graph. To scan a different string, the user may click the current string field, choose a new string from the drop-down menu 450, and click “rescan” to display results for a different selected string. By way of example, the fret numbers are shown on the top of the graph, while the measured difference (deviation) from the target at individual fret positions is shown at the bottom of the graph. Negative values indicate that the position of the fret (fingerboard) is too low (below the target line), while positive values indicate that the position of the fret (fingerboard) is too high (above the target line). In some embodiments, the truss rod scan graph 448 can be activated and deactivated by clicking on an associated icon located on the left side of the screen.

In some embodiments, the computer 16 may display to the user a Scale & Fret Placement window 458, shown by way of example in FIG. 66. In some embodiments, the Scale & Fret Placement window 458 is a representation of the scanned data pertaining to fret distances relative to the measured scale, indicating the accuracy of fret positioning and the spacing between strings and the fingerboard edges. By way of example, the collected and displayed data includes measurements at the nut, 1st fret, 12th fret, and bridge, as well as the fingerboard radius at these positions. In some embodiments, the computer 16 analyzes the data and displays the analyzed status of the frets in a status section 460. For example, the computer 16 may display an analysis of “Fret is closer to the nut than expected” and/or “Fret is further away from the nut than expected “and/or “Fret is within the expected distance from the nut.”

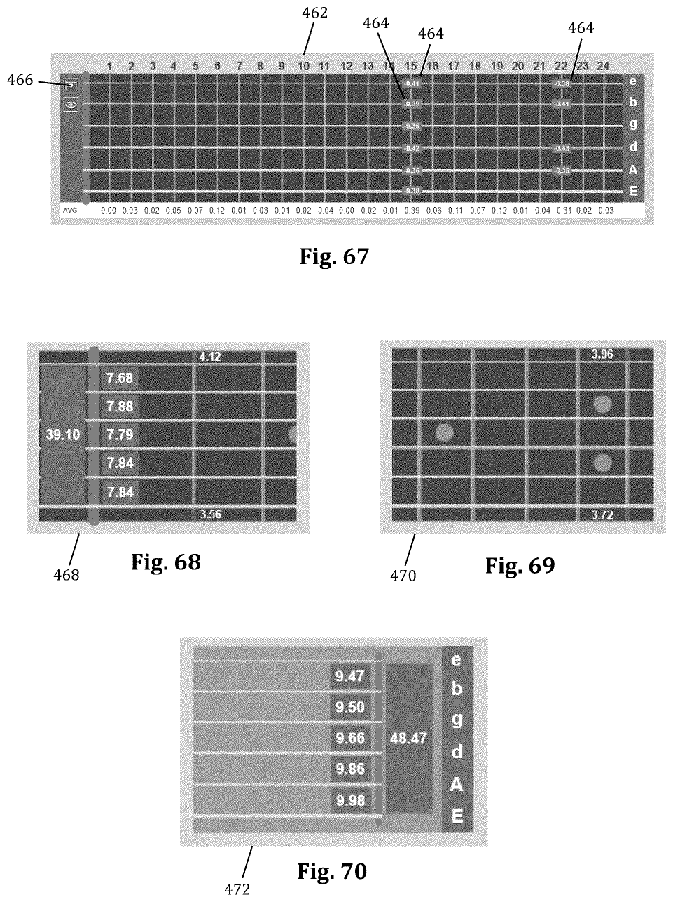

In some embodiments, the Scale & Fret Placement window 458 further includes a fret placement graph 462 (Sec, e.g., FIG. 66 and FIG. 67). By way of example, the fret placement graph 462 shows measurements for each string at every fret. In some embodiments, if a fret is misaligned, the computer 16 displays a misalignment indicator 464 to highlight a deviation from the ideal position. In some embodiments, the misalignment indicator 464 may be highlighted in a red box. By way of example, negative values indicate the fret is closer to the nut than expected, while positive values indicate the fret is further away from the nut than expected. In some embodiments, the average deviation for each fret (e.g., the sum of the deviations divided by the number of strings) is shown below the graph.

In some embodiments, the fret placement graph 462 enables a user to assess the accuracy of the instrument's intonation at each fret. For example, minor deviations from the ideal placement (within a 0.3 mm tolerance) are acceptable and will not be highlighted, as they do not significantly impact the intonation. In some embodiments, the user may click or press an icon 466 on the left side of the fret placement graph 462 to display measurements for each fret.

In some embodiments, the user may set the reference fret by clicking or pressing any fret (except the first fret) to set it as the reference point for calculating the scale. In some embodiments, the default reference is the 12th fret. By way of example, if the user selects the 5th fret as the reference fret, the computer 16 will calculate the scale based on the distance between the 1st and 5th frets. If the user selects the 20th fret, the computer 16 will calculate the scale based on the distance between the 1st and 20th frets.

If all the frets are placed correctly, the fret placement graph 462 should show minimal deviation when switching between reference frets. However, some instruments may have misplaced frets or use outdated placement methods, leading to shifts in fret positions and intonation issues.

If the graph shows significant deviation (e.g., frets too close or too far from their ideal position), the user should switch between reference frets to find the position where the deviation is smallest. This will help determine the instrument's scale length and assist in troubleshooting intonation problems. Based on this data, the user can also make more informed decisions about nut and saddle compensation.

In some embodiments, the computer 16 may also display to the user graphical representation of string spacing at the nut 468, spacing between string and neck 470, and string spacing at the saddle 472. In some embodiments, string spacing at the nut 468, spacing between string and neck 470, and string spacing at the saddle 472 may each be displayed in the Scale & Fret Placement window 458. By way of example, the spring spacing at the nut graph 468 is positioned at the bottom left of the Scale & Fret Placement window 458 and is also shown by way of example in isolation in FIG. 68. In some embodiments, the spring spacing at the nut graph 468 may indicate the spacing between individual strings, as well as the distance between the highest and lowest-pitched strings.

Measurements can be taken either from the edge of one string to the edge of the next, or from the center of each string. You can toggle between metric and imperial units by clicking on the values.

By way of example, the spacing between string and neck graph 470 is positioned at the bottom middle of the Scale & Fret Placement window 458 and is also shown by way of example in isolation in FIG. 69. In some embodiments, the string-to-neck edge distance may be measured at the 1st fret, from the edge of the lowest and highest-pitched strings to the edge of the fingerboard. In some embodiments, the string-to-neck edge distance may also be displayed for the 12th fret.

By way of example, the spring spacing at the saddle graph 472 is positioned at the bottom right of the Scale & Fret Placement window 458 and is also shown by way of example in isolation in FIG. 70. In some embodiments, the spring spacing at the saddle graph 472 may indicate the spacing between individual strings, as well as the distance between the highest and lowest-pitched strings.

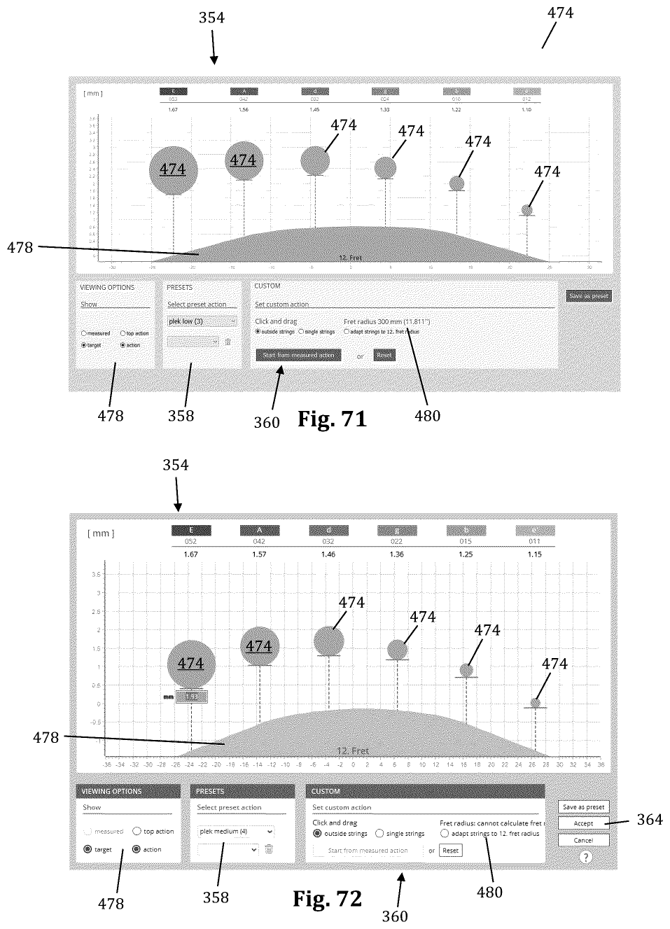

Referring now to FIGS. 71-72, in some embodiments, selecting a string set prompts the computer 16 to activate the Action Setup button which in turn opens the Action Setup window 354, allowing the user to set a target action. By way of example, each large circle 474 (e.g., may be color coded) represents a string in cross-section, positioned above the fretboard 476.

In some embodiments, the “Target” action is automatically selected in the Viewing Options section 478. In some embodiments, the user may choose a preset action by clicking or pressing the pulldown menu in the preset action section 358 or create a custom action by dragging the large circles 474 representing the outer strings (left and right) to a desired height or double-clicking on a large circle 474 representing a string to enter a numerical value. In some embodiments, the user can change the units of measurement by selecting the appropriate radio button in the Measurement Unit controls at the bottom right of the screen. In some embodiments, individual string values can also be adjusted by selecting the Adapt Strings to Radius radio button 480. If the user is satisfied with the selected actions, the user can click or press the Accept button 364 to confirm the settings and return to the scan setup dialog. By way of example, for a basic scan, all default options in the Basics tab can remain unchanged.

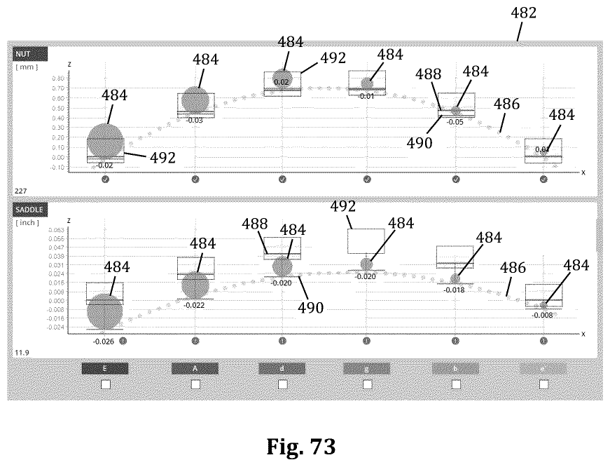

In some embodiments, the computer 16 may present the user with a nut and saddle setup window 482, shown by way of example in FIG. 73. By way of example, the nut and saddle setup window 482 may be used to adjust the string height at the bridge and the depth of the nut slots, both of which are crucial for achieving the desired string action and meeting the user's target action. In some embodiments, the nut and saddle setup window 482 may include large circles (e.g., which may be color coded) representing a cross-sectional view of the strings, a curved dotted line 486 indicating the approximated radius, a target action line 488 for each string, a measured action line 490 for each string, and a dashed line box representing the Plek tolerance range 492.

If the curved dotted line 486 falls within the Plek tolerance range 492, the computer may display an indicator (e.g., green checkmark) to indicate to the user that the string has met the target action. If the curved dotted line 486 is outside the Plek tolerance range 492, the computer may display a warning indicator (e.g., warning triangle) to indicate to the user that the string has not met the target action. In some embodiments, the number next to the measured action line 490 indicates the distance between the measured action line 490 and the target action line 488. In some embodiments, the radius at both the nut and saddle may be displayed numerically at the bottom left of each graph. In some embodiments, the user can toggle between metric and imperial units by clicking on the units in the top left of each graph. In some embodiments, if the string's position falls within the set tolerance, the computer 16 may display an indicator (e.g., green checkmark) communicating that to a user below that string. To re-scan one or more strings, the user may select the checkboxes at the bottom and click START.

FIGS. 74-75 are example block diagrams of computer-implemented electronic devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart-phones, and other similar computing devices. In this example, computing device 550 may represent hand-held computing device 26, while computing device 500 may represent stationary computer 22 and/or computing systems that serve as the cloud 21 referenced in this disclosure. The components shown here, their connections and relationships, and their functions, are meant to be examples only, and are not meant to limit implementations described and/or claimed in this document.

Referring to FIG. 74, computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a graphic user interface (GUI) on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. By way of example only, the memory 504 may be a volatile memory unit, non-volatile memory unit, or another form of computer-readable medium, such as a magnetic or optical disk (for example).

The storage device 506 is capable of providing mass storage for the computing device 500. In one implementation, the storage device 506 may be or contain a non-transitory computer-readable medium (e.g., any and all computer-readable media except transitory, propagating signals), such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed interface 508 manages bandwidth-intensive operations for the computing device 500, while the low-speed interface 512 manages lower bandwidth-intensive operations. Such allocation of functions is by way of example only. In one implementation, the high-speed interface 508 is coupled to memory 504, display 516 (e.g., through a graphics processor or accelerator), and to high-speed expansion ports 510, which may accept various expansion cards (not shown). In the implementation, low-speed interface 512 is coupled to storage device 506 and low-speed expansion port 514. The low-speed expansion port may include various communication ports (or “communications modules,” e.g., USB, Bluetooth, Ethernet, wireless Ethernet, Wi-Fi) and may be coupled to one or more input/output devices, such as a keyboard 518, a printer 520, a scanner 522, or a networking device such as a switch or router 524, e.g., through a network adapter.

The computing device 500 may be implemented in a number of different forms. For example, it may be implemented as a standard server, or multiple times in a group of such servers. It may also be implemented as part of a rack server system. In addition, it may be implemented in a personal computer such as a laptop computer. Alternatively, components from computing device 500 may be combined with other components in a mobile device, such as device 550 (FIG. 75). Each of such devices may contain one or more of computing device 500, 550, and an entire system may be made up of multiple computing devices 500, 550 communicating with each other.

Referring to FIG. 75, computing device 550 includes a processor 552, memory 554, an input/output device such as a display 556, a communication interface 558, and a transceiver 560, among other components. The device 550 may also be provided with a storage device, such as a microdrive or other device, to provide additional storage. Each of the components 550, 552, 554, 556, 558, and 560, are interconnected using various buses, and several of the components may be mounted on a common motherboard or in other manners as appropriate.

The processor 552 can execute instructions within the computing device 550, including instructions stored in the memory 554. The processor may be implemented as a chipset of chips that include separate and multiple analog and digital processors. Additionally, the processor may be implemented using any of a number of architectures. For example, the processor 552 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

The processor 552 may communicate with a user through control interface 562 and display interface 564 coupled to a display 556. The display 556 may be, for example, a TFT (Thin-Film-Transistor Liquid Crystal Display) display or an OLED (Organic Light Emitting Diode) display, or other appropriate display technology. The display interface 564 may comprise appropriate circuitry for driving the display 556 to present graphical and other information to a user. The control interface 562 may receive commands from a user and convert them for submission to the processor 552. In addition, an external interface 566 may be provided in communication with processor 552, so as to enable near area communication of device 550 with other devices. External interface 566 may provide, for example, for wired communication in some implementations, or for wireless communication in other implementations, and multiple interfaces may also be used.

The memory 554 stores information within the computing device 550. The memory 554 can be implemented as one or more of a computer-readable medium or media, a volatile memory unit or units, or a non-volatile memory unit or units. Expansion memory 568 may also be provided and connected to device 550 through expansion interface 570, which may include, for example, a SIMM (Single in Line Memory Module) card interface. Such expansion memory 568 may provide extra storage space for device 550 or may also store applications or other information for device 550. Specifically, expansion memory 568 may include instructions to carry out or supplement the processes described above and may include secure information also. Thus, for example, expansion memory 568 may be provided as a security module for device 550 and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, cause performance of one or more methods, such as those described above. The information carrier is a computer- or machine-readable medium, such as the memory 554, expansion memory 568, or memory on processor 552 that may be received, for example, over transceiver 560 or external interface 566.

Device 550 may communicate wirelessly through communication interface 558, which may include digital signal processing circuitry where necessary. Communication interface 558 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 560. In addition, short-range communication may occur, such as using a Bluetooth, WiFi, or other such transceiver (not shown). In addition, GPS (Global Positioning System) receiver module 572 may provide additional navigation- and location-related wireless data to device 550, which may be used as appropriate by applications running on device 550.

Device 550 may also communicate audibly using audio codec 574, which may receive spoken information from a user and convert it to usable digital information. Audio codec 574 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, some of which are shown in the figure. For example, it may be implemented as a cellular telephone. It may also be implemented as part of a smart-phone, personal digital assistant, or other similar mobile device.

Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. Furthermore, the use of plurals can also refer to the singular, including without limitation when a term refers to one or more of a particular item; likewise, the use of a singular term can also include the plural, unless the context dictates otherwise.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Any of the features or attributes of the above the above-described embodiments and variations can be used in combination with any of the other features and attributes of the above-described embodiments and variations as desired. From the foregoing disclosure and detailed description of certain preferred embodiments, it is also apparent that various modifications, additions and other alternative embodiments are possible without departing from the true scope and spirit. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A portable musical instrument scanning system configured for performing quality control assessment and diagnosis for stringed musical instruments, comprising:
an instrument holder configured to receive a stringed musical instrument, the instrument holder comprising a vertical support member, an adjustable upper instrument coupling assembly movably associated with the vertical support member, and an adjustable lower instrument coupling assembly translatably coupled to the vertical support member;
a scanner assembly translatably coupled to the instrument holder, the scanner assembly including a scanner configured to scan the surface of a musical instrument received within the instrument holder to collect data relating to the received stringed musical instrument; and
a computer program product embodied in a non-transitory computer-readable storage medium comprising a set of instructions that, when executed by a processor, are configured to cause a computer system to:
(1) operate the scanner to collect the data relating to the stringed musical instrument received within the instrument holder;
(2) analyze the data collected by the computer system through operation of the scanner against predetermined data parameters; and
(3) display, on a display unit of the computer system, results of the analysis including a recommended disposition of the stringed musical instrument.

2. The portable musical instrument scanning system of claim 1, wherein the scanner assembly further comprises a vertical translation member slidably coupled to the vertical support member.

3. The portable musical instrument scanning system of claim 2, wherein the scanner assembly further comprises a transverse translation member slideably coupled to a transverse housing that is rigidly coupled to the vertical translation member.

4. The portable musical instrument scanning system of claim 3, wherein the scanner is coupled to the transverse translation member.

5. The portable musical instrument scanning system of claim 1, wherein the scanning assembly is configured for translation in a vertical direction and a transverse direction relative to the instrument holder to maximize the scanning range of the scanner relative to the received stringed musical instrument.

6. The portable musical instrument scanning system of claim 1, wherein adjustable upper instrument coupling assembly is configured to receive a headstock of a stringed musical instrument.

7. The portable musical instrument scanning system of claim 1, wherein the lower instrument coupling assembly is configured to receive a body of a stringed musical instrument.

8. The portable musical instrument scanning system of claim 1, wherein the computer system comprises a smart phone, smart watch, tablet computer, desktop computer, or a laptop computer.

9. The portable musical instrument scanning system of claim 1, wherein the instrument holder includes one or more line lasers configured to achieve an overlapped alignment on the surface of the received stringed musical instrument when the received stringed musical instrument is properly positioned within the instrument holder.

10. The portable musical instrument scanning system of claim 1, wherein the data collected by the scanner includes string data.

11. The portable musical instrument scanning system of claim 1, wherein the data collected by the scanner includes fretboard data.

12. The portable musical instrument scanning system of claim 1, wherein the data collected by the scanner includes nut data or saddle data.

13. The portable musical instrument scanning system of claim 1, wherein the predetermined data parameters comprise a custom string configuration input into the computer system by a user.

14. The portable musical instrument scanning system of claim 1, wherein the recommended disposition of the stringed musical instrument includes at least one of a repair recommendation, an adjustment recommendation, and a release recommendation.

15. The portable musical instrument scanning system of claim 1, wherein the scanner comprises a high-resolution scanner.
